(19) United States
(12) Patent Application Publication
(10) Pub. No.: US 2025/0220519 A1
(43) Pub. Date: Jul. 3, 2025

(54) FORWARDING OPERATIONS DURING REPEATER MIGRATION

(71) Applicant: QUALCOMM Incorporated, San Diego, CA (US)

(72) Inventors: Naeem AKL, Bridgewater, NJ (US); Navid ABEDINI, Basking Ridge, NJ (US)

(21) Appl. No.: 18/399,118

(22) Filed: Dec. 28, 2023

(51) Int. Cl. H04W 36/00; H04W 36/10; H04W 56/00

(52) U.S. Cl. CPC H04W 36/0061; H04W 36/10; H04W 56/0015

(57) ABSTRACT

Certain aspects of the present disclosure provide techniques for managing forwarding operations during repeater migration. An example method performed by a network-controlled repeater (NCR) device includes receiving, from a first network entity associated with a source cell, a first forwarding configuration for the source cell for configuring the NCR device to forward a first plurality of signals, received at the NCR device, to one or more user equipments (UEs), receiving the first plurality of signals, forwarding the first plurality of signals to the one or more UEs in accordance with the first forwarding configuration for the source cell, receiving, from the first network entity, a handover (HO) command instructing the NCR device to handover to a second network entity associated with a target cell, and taking one or more actions related to forwarding signals to the one or more UEs in response to receiving the HO command.

### BACKGROUND

### Field of the Disclosure

Aspects of the present disclosure relate to wireless communications, and more particularly, to techniques for managing forwarding operations during repeater migration.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network-controlled repeater (NCR) device. The method includes receiving, from a first network entity associated with a source cell, a first forwarding configuration for the source cell for configuring the NCR device to forward a first plurality of signals, received at the NCR device, to one or more user equipments (UEs); receiving the first plurality of signals; forwarding the first plurality of signals to the one or more UEs in accordance with the first forwarding configuration for the source cell; receiving, from the first network entity, a handover (HO) command instructing the NCR device to handover from the first network entity associated with the source cell to a second network entity associated with a target cell; and taking one or more actions related to forwarding signals to the one or more UEs in response to receiving the HO command.

Another aspect provides a method for wireless communication by a first network entity associated with a source cell. The method includes transmitting, to a network-controlled repeater (NCR) device, a first forwarding configuration for the source cell for configuring the NCR device to forward a first plurality of signals, received at the NCR device, to one or more user equipments (UEs); transmitting a first set of signals of the first plurality of signals to the NCR device for forwarding to the one or more UEs based on the first forwarding configuration; and transmitting a handover (HO) command instructing the NCR device to handover from the first network entity associated with the source cell to a second network entity associated with a target cell.

Another aspect provides a method for wireless communication by a second network entity associated with a target cell. The method includes receiving a HO request message from a first network entity associated with a source cell, requesting a handover of a network-controlled repeater (NCR) device to the second network entity associated with the target cell, wherein the HO request includes an indication of a first forwarding configuration for the source cell for configuring the NCR device to forward a first plurality of signals, received at the NCR device, to one or more user equipments (UEs); and transmitting a HO request acknowledgement message to the first network entity associated with the source cell approving the handover of the NCR device, wherein the HO request acknowledgement message includes an indication of a second forwarding configuration for the target cell for configuring the NCR device to forward a second plurality of signals, received at the NCR device, to the one or more UEs.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 provides a simplified call flow diagram, illustrating example operations for handing a user equipment (UE) over to a target gNodeB (gNB) from a source gNB.

FIG. 6 provides an illustration of an example NCR device for forwarding signals between a network entity and a UE.

FIGS. 7A, 7B, and 7C illustrate a handover of an NCR device from a first network entity to a second network entity.

FIG. 8 depicts a process flow for communications in a network between a first network entity, a second network entity, a network-controlled repeater (NCR) device, and one or more UEs.

FIG. 9 depicts a method for wireless communications.

FIG. 10 depicts a method for wireless communications.

FIG. 11 depicts a method for wireless communications.

FIG. 12 depicts aspects of an example communications device.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for managing forwarding operations during repeater migration.

For example, in some cases, a wireless network may employ wireless repeater devices to improve coverage and throughput in wireless network by forwarding signals between a network entity and a user equipment. Currently, such repeaters are fully network-controlled. A network-control repeater (NCR) may amplify-and-forward signals it receives without performing any decoding. An NCR may use transmit and receive beamforming to control interference. An NCR may receive and process control information from the base station that configures the NCR's amplify and forward operations. Thus, the NCR can be logically a part of the base station for management purposes. In some aspects, NCRs are in-band RF repeaters used for extension of network coverage in the FR1 and FR2 bands and may operate transparently to the UE. After power amplification and with beamforming, the NCR forwards a received RF signal in the uplink or downlink. Since the NCR-forward only amplifies and beamforms the RF signal, the NCR may not use any advanced digital receiver or transmitter chains.

In some cases, the forwarding of RF signals by NCR device may be controlled by a forwarding configuration. The forwarding configuration may include, among other things, one or more beam indices, each beam index corresponding to a respective communication beam for the NCR device to use when forwarding signals between the network entity and the UE.

Typically an NCR device is a stationary repeater and may be used to forward signals between the network entity and one or more UEs according to the forwarding configuration. However, there may be some scenarios in which it may be NCR device may be mobile or semi-mobile, which may require the NCR device to be handed over from a first network entity associated with a source cell to second network entity associated with a target cell.

In some cases, forwarding configurations may be specific to the particular cell that is serving the NCR device. For example, when communicating with the first network entity associated with the source cell, the NCR device may be configured to forward signals based on a first forwarding configuration. However, when the NCR device is communicating with the second network entity associated with the target cell, for example, after handover, the NCR device may be configured to forward signals based on second forwarding configuration.

As such, when handing the NCR device over from the first network entity to the second network entity, the handover may involve a transition from the first forwarding configuration associated with the source cell to the second forwarding configuration associated with the target cell. In some cases, the transition from first the first forwarding configuration associated with the source cell to the second forwarding configuration associated with the target cell may take a certain amount of time, which may be known as a transient phase. For example, the transient phase may represent a period of time between reception of a handover command (e.g., instructing the NCR device to handover to the second network entity) and reception of the second forwarding configuration.

During the transient phase, it is currently unspecified how the NCR device 706 should behave with respect to forwarding signals between the UE and one of the first network entity or the second network entity. For example, during the transient phase, it is unspecified whether the NCR device should continue to forward signals between the first network entity and the UE or whether the NCR device should refrain from forwarding the signals. Similarly, while connected with the first network entity, in some cases, the NCR device may be configured to forward signals received from the second network entity to the UE, such as reference signals (e.g., synchronization signal blocks (SSBs)). Similarly, during the transient phase, it is unspecified whether the NCR device should continue to forward signals from the second network entity to the UE or whether the NCR device should refrain from forwarding these signals.

Accordingly, aspects of the present disclosure provide different options for defining the behavior of the NCR device during a handover of the NCR device from the first network entity associated with the source cell to the second network entity associated with the target cell. Additionally, aspects of the present disclosure provide different options reducing an amount of time for receiving and applying a forwarding configuration associated with the second network entity (e.g., the second forwarding configuration for the target cell) after completion of the handover to the second network entity.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

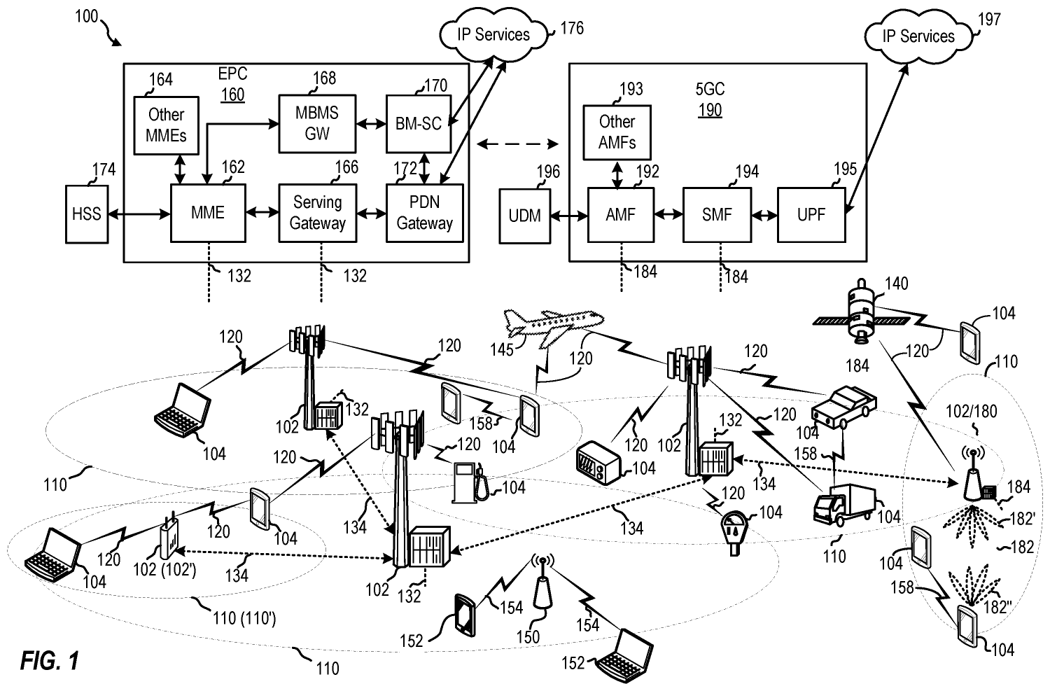

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

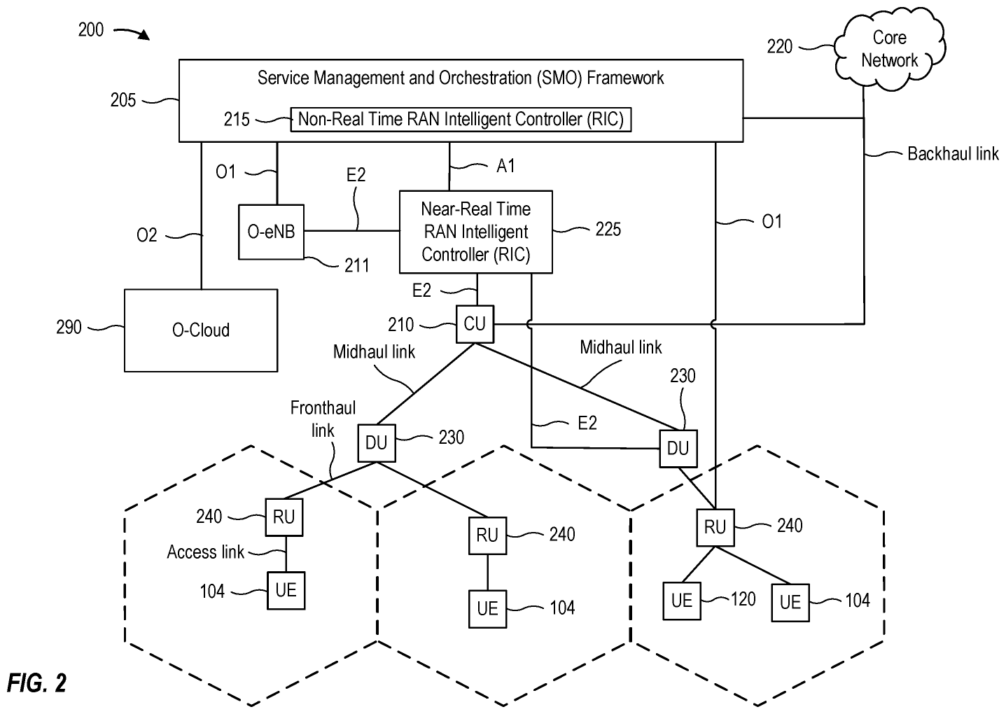

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an FI interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

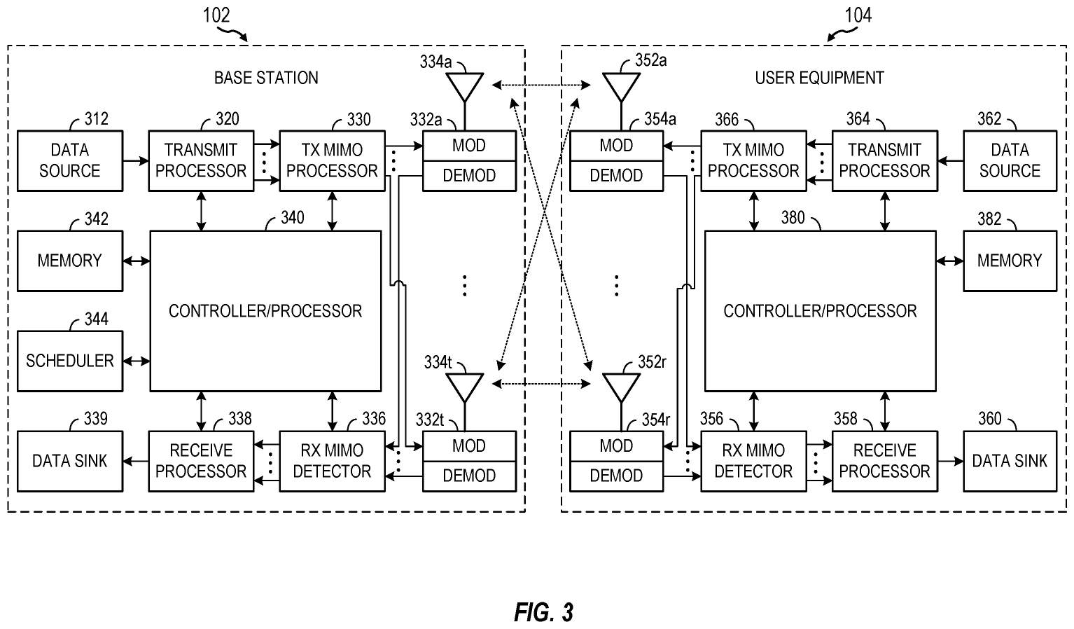

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

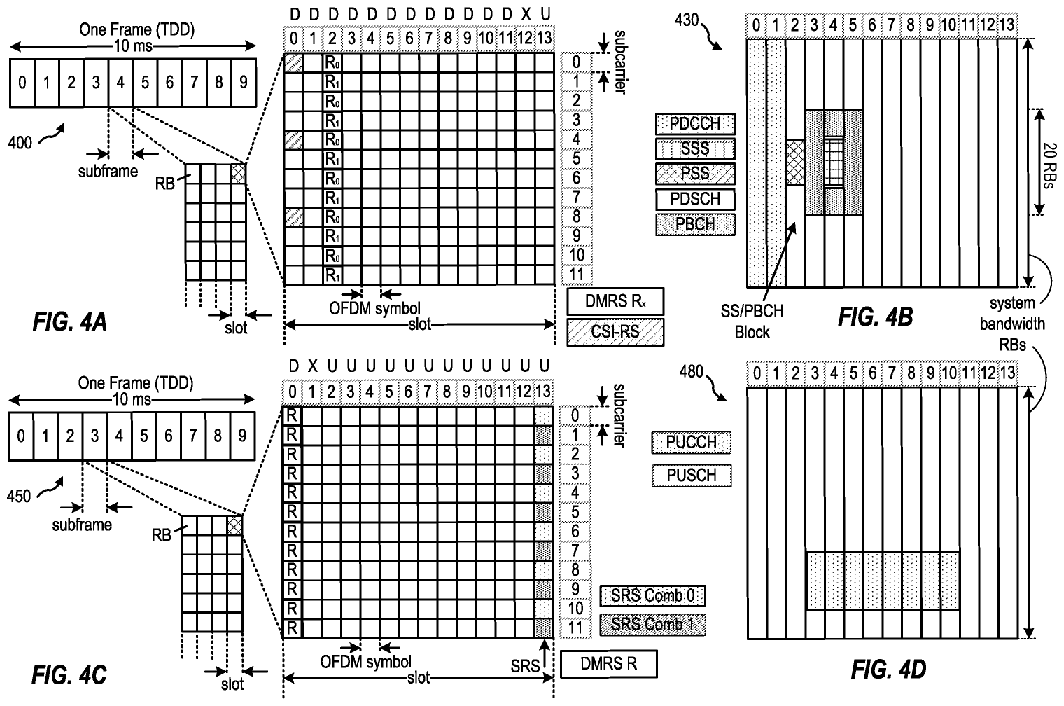

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Mobility and Handovers

A user equipment (UE), such as UE 104, may perform an attach procedure to establish a connection with a first network entity, such as a base station (e.g., BS 102). The UE may continue to use the established connection to communicate with the first network entity as long as the UE remains in a first cell that is being served by the first network entity. However, due to mobility of the UE, there may be scenarios in which the UE may move between cells. In these scenarios, the UE may be handed over from the first network entity associated with the first cell to a second cell associated with a second cell. In this scenario, the first network entity may be known as a source network entity (e.g., source gNB) and the first cell may be known as the source cell. Similarly, the second network entity may be known as the target network entity (e.g., target gNB) and the second cell may be known as the target cell.

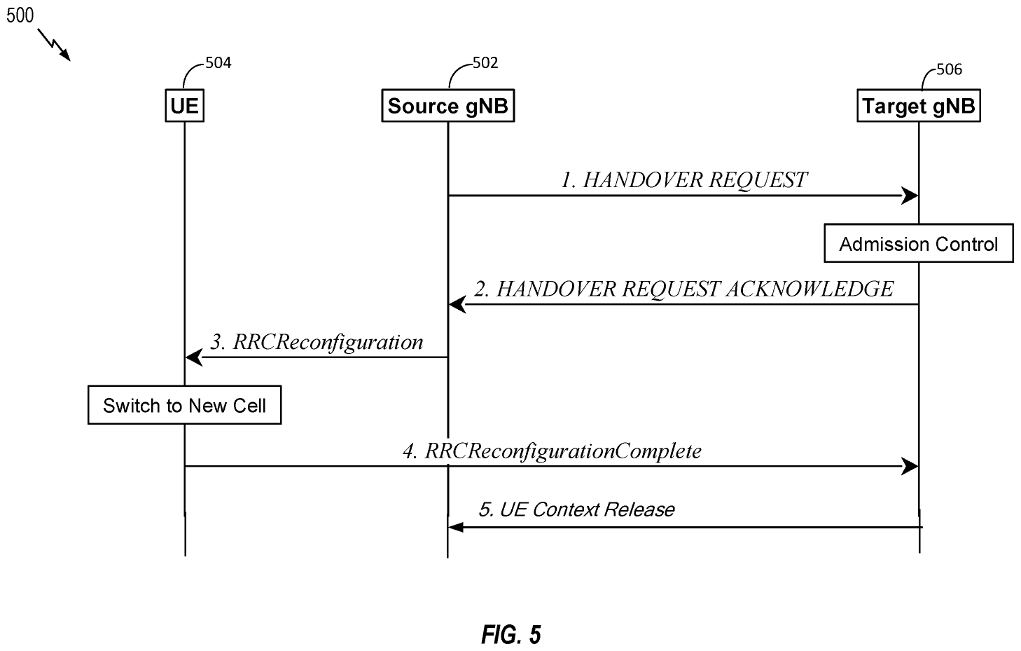

FIG. 5 provides a simplified call flow diagram 500, illustrating example operations for handing a UE 504 over to a target gNB 506 from a source gNB 502. As shown in step 1, the source gNB 502 initiates handover and issues a HANDOVER REQUEST to the target gNB 506 over an Xn interface. In some cases, the handover may be initiated based on radio resource management (RRM) measurements performed by the UE 504 and indicated to the source gNB 502. In some cases, the RRM measurements may be based on synchronization signal blocks (SSBs) received by the UE 504 from the source gNB 502, the target gNB 506, and/or other neighboring network entities. For example, in some cases, based on the RRM measurements, the source gNB 502 may determine that the target gNB 506 is better suited to serve the UE 504.

Thereafter, the target gNB 506 performs admission control and provides a new radio resource control (RRC) configuration as part of a HANDOVER REQUEST ACKNOWLEDGE message transmitted by the target gNB 506 to the source gNB 502, as shown in step 2. Thereafter, in step 3, the source gNB 502 provides the RRC configuration to the UE 504 by forwarding an RRCReconfiguration message (e.g., a handover command) received in the HANDOVER REQUEST ACKNOWLEDGE message. The UE 504 may then switch the RRC connection to the target gNB 506 and replies to the target gNB 506 with an RRCReconfigurationComplete, as shown in step 4. Thereafter, the target gNB 506 sends a UE CONTEXT RELEASE message to the source gNB 502 indicating that the handover of the UE 504 was successfully completed.

### Aspects Related to Forwarding Operations During Repeater Migration

In some cases, a wireless network may employ wireless repeater devices to improve coverage and throughput in wireless network by forwarding signals between a network entity (e.g., BS 102) and a user equipment (UE 104). In some cases, different types of wireless repeater devices may be employed. One such wireless repeater device may include a traditional or legacy type wireless repeater, known as a radio frequency (RF) repeater, that is configured to receive signals from a transmitter device (e.g., the network entity or the UE), amplify the signals, and forward or retransmit the amplified signals to a receiver device (e.g., the UE or the network entity, respectively). RF repeaters, however, may perform the receiving, amplifying, and retransmitting of the signals in a relatively unintelligent manner, without control from the network entity. As a result, these RF repeaters may not be capable of accurate beamforming, which may limit the level of coverage and throughput improvements that they may provide.

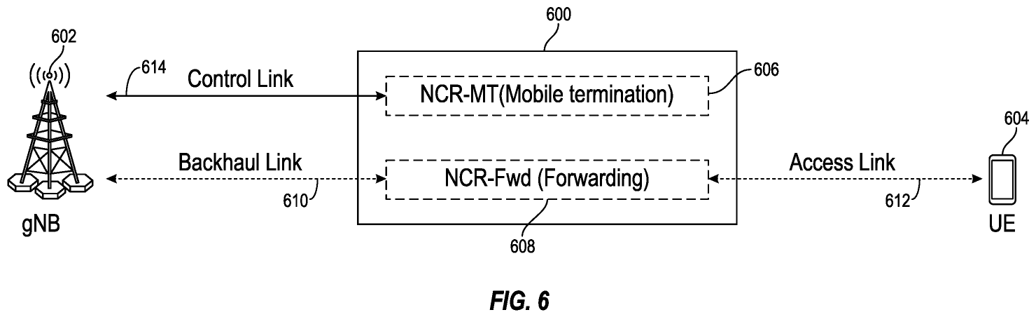

Another type of wireless repeater device that may be employed in a wireless network may include a network-controlled repeater (NCR) device. The NCR device is a repeater with beamforming capabilities that can receive and process side control information from the network entity. Such side control information may allow the NCR device to perform its amplify-and-forward operation in an efficient manner. For example, the side control information may allow the NCR device to control beamforming towards UEs, manage downlink and uplink transmissions, and switch its forwarding functionality on and off. In general, the NCR device may be considered as a network-controlled “beam bender” relative to the network entity, allowing the network entity to effectively bend transmission beams around obstructions to provide coverage to certain UEs. In this manner, the NCR device may logically be part of the network entity for all management purposes. In other words, it may be assumed that the NCR device is deployed and under the control of an operator of the wireless network and may not have a unique physical layer cell-id, resulting in the NCR device appearing to be “transparent” to a UE. In other words, the UE may not know that it is communicating with the NCR device and instead may believe that it is communicating directly with the network entity. Additional details regarding NCR devices are provided below with respect to FIG. 6.

It should be noted that another method of improving coverage and throughput in a wireless network may be to employ integrated access and backhaul (IAB) nodes, which may provide similar forwarding functionality as an NCR device. However, unlike NCR devices that merely receive, amplify, and forward signals (e.g., without decoding of those signals), IAB nodes are more complex, operating using a decode-and-forward scheme associated with received signals. Additionally, IAB nodes may have functionality up to Layer-2 (L2), may have their own physical layer cell-id.

FIG. 6 provides an illustration of an example NCR device 600 for forwarding signals between a network entity 602 and a UE 604. In some cases, the network entity 602 may be an example of the BS 102 illustrated and described with respect to FIGS. 1 and 3. Similarly, the UE 604 may be an example of the UE 104 illustrated and described with respect to FIGS. 1 and 3.

As shown, the NCR device 600 includes an NCR mobile termination (NCR-MT) logical entity 606 and an NCR forwarding (NCR-FWD) logical entity 608. The NCR-MT logical entity 606 may maintain a Uu-based control link 614 with the network entity 602 and may exchange side control information with the network entity 602. The NCR-FWD logical entity 608 may be used by the NCR device 600 for receiving, amplifying, and forwarding uplink (UL)/downlink (DL) data and/or control information between the network entity 602 and the UE 604, for example, without decoding of that UL/DL data and/or control information.

As shown, the NCR-FWD logical entity 608 may maintain a backhaul link 610 with the network entity 602. The backhaul link 610 may be used for receiving DL data and control information intended for the UE 604 from the network entity 602 and for transmitting UL data and control information to the network entity 602 that is received from the UE 604. Similarly, the NCR-FWD logical entity 608 may maintain an access link 612 with the UE 604. The access link 612 may be used for transmitting the DL data and the control information to the UE 604 that is received from the network entity 602 and for receiving the UL data and the control information intended for the network entity 602 from the UE 604. While the backhaul link 610 and the access link 612 are illustrated as being separate links, the backhaul link 610 and the access link 612 may be considered a single end-to-end access think between network entity 602 and UE 604 that passes through the NCR-FWD logical entity 608 of the NCR device 600.

In some cases, the NCR-MT logical entity 606 may communicate with the network entity 602 on the control link 614 using one or more carrier frequencies. Similarly, the NCR-FWD logical entity 608 may communicate with the network entity 602 on the backhaul link 610 and with the UE 604 on the access link 612 (e.g., collectively, on the access link) using one or more carrier frequencies. In some cases, the one or more carrier frequencies used by the NCR-MT logical entity 606 may operate in a same frequency band as used for forwarding the UL/DL data and/or control information by the NCR-FWD logical entity 608. Additionally, in some cases, transmission and reception on control link 614 and backhaul link 610 may be time division multiplexed or performed simultaneously based on a capability of the NCR device 600.

In some cases, the side control information may include a forwarding configuration for the NCR-FWD logical entity 608 of the NCR device 600 to use when forwarding signals between the network entity 602 and the UE 604. In some cases, the forwarding configuration may include configuration information for the access link 612 between the NCR device 600 and the UE 604 as well as configuration information for the backhaul link 610 between the NCR device 600 and the network entity 602. For example, in some cases, the configuration information for the access link 612 may indicate one or more beam indices, each beam index of the one or more beam indices corresponding to a particular communication beam, for communicating on the access link 612 between the NCR device 600 and the UE 604.

In some cases, the forwarding configuration of the side control information may also indicate one or more time resources, associated with the one or more beam indices/communication beams, for communicating with the UE 604 on the access link 612. In some cases, the one or more beam indices may correspond to operations and management (OAM) configured access beams. In some cases, the one or more beam indices for communicating on the access link 612 may be configured (e.g., by network entity 602) aperiodically (e.g., via downlink control information (DCI)), semi-persistently (e.g., via media access control-control element (MAC-CE) signaling and radio resource control (RRC) signaling), or periodically (e.g., via RRC signaling).

In some cases, the configuration information for the backhaul link 610 may include RRC signaling that configures one or more communication beams, each communication beam corresponding to a particular beam index, for the NCR-FWD logical entity 608 to use to communicate with the network entity 602. Additionally, in some cases, the side control information may further include MAC-CE signaling received by the NCR-MT logical entity 606 that semi-persistently configures the NCR-FWD logical entity 608 with a beam index corresponding to a particular communication beam of the one or more communication beams configured via the RRC signaling. In some cases, if the NCR device 600 does not receive an explicit indication of the beam index to use for the backhaul link 610, the NCR device 600 may use one or more pre-defined rules to select the particular communication beam of the one or more communication beams configured via the RRC signaling.

In some cases, the forwarding configuration in the side control information may also provide the NCR device 600 with an ON/OFF indication relating to a forwarding functionality of the NCR-FWD logical entity 608. For example, the ON/OFF state indication may indicate to the NCR-FWD logical entity 608 when to forward signals between the network entity 602 and the UE 604 (e.g., ON state) and when to refrain or stop forwarding signals between the network entity 602 and the UE 604 (e.g., OFF state). In some cases, an ON state indication may be implicitly provided by indicating the one or more beam indices for communicating on the access link 612. In some cases, the NCR-FWD logical entity 608 may be configured by default to be in the OFF state when the side control information does not include an indication of the ON state. In some cases, the NCR-FWD logical entity 608 may be configured by to be in the OFF state within semi-static flexible symbols.

While the NCR device 600 may facilitate the forwarding of signals between the network entity 602 and the UE 604, there may be scenarios in which the NCR device 600 may be handed over from the network entity 602 to another network entity using a similar handover procedure as illustrated in FIG. 5. For example, in some cases, a handover of the NCR device 600 may be necessary when the backhaul link 610 of NCR device 600 degrades. In some cases, the NCR device 600 may be portable or user-deployed (e.g., a public safety use case, where repeater provides coverage extension in ad hoc manner), allowing the NCR device 600 to move locations or cells, which may require the handover from the network entity 602 (e.g., associated with a first cell) to the other network entity (e.g., associated with a second cell).

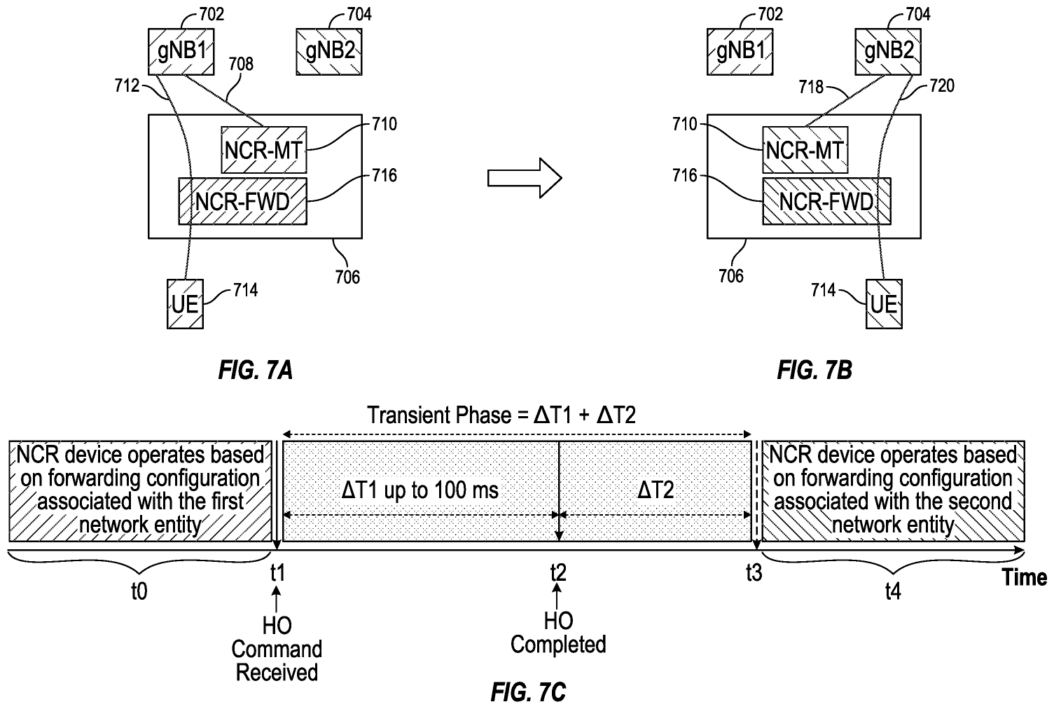

However, mobility and handovers of the NCR device 600 may present issues related to the forwarding functionality of the NCR device 600, which are illustrated by FIGS. 7A, 7B, and 7C. For example, FIGS. 7A and 7B illustrate a handover of an NCR device 706 from a first network entity 702 to a second network entity 704. In some cases, the NCR device 706 may be an example of the NCR device 600 illustrated and described with respect to FIG. 6. Similarly, the first network entity 702 may be an example of the network entity 602 illustrated and described with respect to FIG. 6. Additionally, the second network entity 704 may be another example of the network entity 602 illustrated and described with respect to FIG. 6. In some cases, the first network entity 702 may be associated with a source cell while the second network entity 704 may be associated with a target cell.

As shown in FIG. 7A, a first control link 708 may be established between an NCR-MT logical entity 710 of the NCR device 706 and the first network entity 702 for communicating side control information, such as a first forwarding configuration for the NCR-FWD logical entity 716 for the source cell (e.g., for the NCR-FWD logical entity 716 to use when connected to the source cell). Further, as shown, a first access link 712 may be established between the first network entity 702 and a UE 714 through an NCR-FWD logical entity 716 of the NCR device 706 for communicating UL/DL data or control information between the first network entity 702 and the UE 714 according to the first forwarding configuration. As noted above, the first access link 712 may collectively refer to a plurality of links established by the NCR-FWD logical entity 716, such as a backhaul link established between the first network entity 702 and the NCR-FWD logical entity 716 (e.g., backhaul link 610 illustrated and described with respect to FIG. 6) and an access link established between the NCR-FWD logical entity 716 and the UE 714 (e.g., access link 612 illustrated and described with respect to FIG. 6).

As noted above, in some cases due to mobility of the NCR device 706, the NCR device 706 may be handed over from the first network entity 702 to the second network entity 704. For example, as shown in FIG. 7B, after the handover of the NCR device 706 occurs, a second control link 718 may be established between the NCR-MT logical entity 710 of the NCR device 706 and the second network entity 704 for communicating side control information, such as a second forwarding configuration for the NCR-FWD logical entity 716 for the target cell (e.g., for the NCR-FWD logical entity 716 to use when connected to the target cell). Further, as shown, a second access link 720 may be established between the second network entity 704 and the UE 714 through the NCR-FWD logical entity 716 of the NCR device 706 for communicating UL/DL data or control information between the second network entity 704 and the UE 714 according to the second forwarding configuration. As noted above, the second access link 720 may collectively refer to a plurality of links established by the NCR-FWD logical entity 716, such as a backhaul link established between the second network entity 704 and the NCR-FWD logical entity 716 and an access link established between the NCR-FWD logical entity 716 and the UE 714.

FIG. 7C illustrates a timeline 730 of the handover of the NCR device 706 from the first network entity 702 to the second network entity 704. For example, as illustrated, during the time period labeled t0, the NCR device 706 may be connected to the first network entity 702 (e.g., via the first control link 708 and the first access link 712) and forwarding signals between the first network entity 702 and the UE 714 according to the first forwarding configuration for the source cell (e.g., beam index, time resources, ON/OFF indication, etc.). Thereafter, at time t1, the NCR-MT logical entity 710 of the NCR device 706 may receive a handover (HO) command from the first network entity 702 that the NCR device to handover from the first network entity 702 associated with the source cell to the second network entity 704 associated with a target cell. In some cases, the HO command may be based on RRM measurements (e.g., SSB measurements) performed by the NCR device 706 and provided to the first network entity 702.

Thereafter, based on the HO command, a HO procedure may be performed to hand over the NCR device 706 (e.g., the NCR-MT logical entity 710) from the first network entity 702 to the second network entity 704. As shown at time t2, the HO procedure may be completed and at least the second control link 718 may be established between the second network entity 704 and the NCR-MT logical entity 710 of the NCR device 706. In some cases, the time it takes to complete the HO procedure is represented by ΔT1, which may be up to 100 milliseconds.

Additionally, in some cases, once the HO procedure is completed at time t2 and the NCR device 706 has been handed over to the second network entity 704, there may be an additional period of time labeled ΔT2 before the NCR device 706 receives, at t3, the second forwarding configuration for the target cell that enables the NCR-FWD logical entity 716 of the NCR device 706 to forward UL/DL data or control information between the second network entity 704 and the UE 714. Accordingly, the total period of time or transient phase between reception of the HO command and reception of the second forwarding configuration (e.g., that enables the NCR device 706 to begin forwarding signals between the second network entity 704 and the UE 714) may be represented as ΔT1+ΔT2. After receiving the second forwarding configuration at time t3, the NCR-FWD logical entity 716 of the NCR device 706 may begin forwarding signals between the second network entity 704 and the UE 714, as shown in the time period labeled t4, in accordance with the second forwarding configuration for the target cell.

During the transient phase, it is currently unclear how the NCR-FWD logical entity 716 of the NCR device 706 should behave with respect to forwarding signals between the UE 714 and one of the first network entity 702 or the second network entity 704. For example, during the transient phase, it is unclear whether the NCR-FWD logical entity 716 should continue to forward signals between the first network entity 702 and the UE 714 or whether the NCR-FWD logical entity 716 should refrain from forwarding the signals. Similarly, while connected with the first network entity 702, in some cases, the NCR-FWD logical entity 716 may be configured to forward signals received from the second network entity 704 to the UE 714, such as reference signals (e.g., SSBs). As such, during the transient phase, it is unclear whether the NCR-FWD logical entity 716 should continue to forward signals from the second network entity 704 to the UE 714 or whether the NCR-FWD logical entity 716 should refrain from forwarding these signals.

Additionally, as noted above, the transient phase may include the additional period of time labeled ΔT2 in FIG. 7C, which represents the time between completion of the HO procedure at time t2 and reception (and implementation of) the second forwarding configuration for the target cell associated with the second network entity 704. This additional period of time may be undesirable as it increases the amount of time during with the NCR-FWD logical entity 716 may not be forwarding signals to/from the UE 714, which may cause an interruption of service to the UE 714 and lead to poor user experience. In some cases, this service interruption may lead to radio link failure (RLF) of the UE 714, which further increases the amount of time that service to the UE 714 is interrupted and may force the UE 714 to unnecessarily consume time-frequency and power resources associated with performing a link recovery procedure to reestablish a communication link with a network entity (e.g., the first network entity 702 or the second network entity 704).

Accordingly, aspects of the present disclosure provide different options for defining the behavior of an NCR device, such as the NCR device 706, during a handover of the NCR device from the first network entity 702 associated with the source cell to the second network entity 704 associated with the target cell. Additionally, aspects of the present disclosure provide different options reducing an amount of time for receiving and applying a forwarding configuration associated with the second network entity 704 (e.g., the second forwarding configuration for the target cell) after completion of the handover to the second network entity 704.

For example, a first option (e.g., Option 1) may involve the NCR device 706 being configured to switch the NCR-FWD logical entity 716 OFF in response to receiving the HO command that triggers the handover of the NCR device 706 to the second network entity 704. In other words, the HO command may provide an explicit or implicit OFF indication to the NCR device 706, instructing the NCR device 706 to place the NCR-FWD logical entity 716 in an OFF state in which the NCR-FWD logical entity 716 refrains from forwarding any signals. After successful completion of the handover the NCR device 706 may receive the second forwarding configuration for the target cell from the second network entity 704. Thereafter, after successful completion of the handover and after reception of the second forwarding configuration for the target cell, the NCR device 706 may be configured to start forwarding signaling between the second network entity 704 and the UE 714 in accordance with the second forwarding configuration for the target cell.

Similar to the first option described above, a second option (e.g., Option 2) may also involve the NCR device 706 being configured to switch the NCR-FWD logical entity 716 OFF in response to receiving the HO command that triggers the handover of the NCR device 706 to the second network entity 704. However, unlike the first option, the second option may involve indicating the second forwarding configuration for the target cell in the HO command, allowing the NCR device 706 to begin forwarding signals between the second network entity 704 and the UE 714 upon successful completion of the handover. In some cases, by indicating the second forwarding configuration for the target cell in the HO command, the additional time period labeled ΔT2 of the transient phase shown in FIG. 7C may be eliminated or significantly reduced, thereby reducing the service interruption associated with the UE 714, improving user experience, and avoiding the unnecessary consumption of time-frequency resources and power resources associated with link recovery procedures described above.

A third option (e.g., Option 3) may involve the NCR device 706 being configured to switch OFF, at the NCR-FWD logical entity 716, the forwarding of signals for the source cell (e.g., to/from the first network entity 702) upon receiving the HO command. However, if the NCR device 706 was forwarding signals for the target cell (e.g., to/from the second network entity 704 and/or UE 714) prior to receiving the HO command (e.g., reference signal/SSB forwarding from the second network entity 704 associated with the target cell) in accordance with the first forwarding configuration for the source cell, the NCR device 706 may continue to forward the signals to/from the second network entity 704 associated with the target cell following the reception of the HO command and during the handover procedure triggered by the HO command. Thereafter, once the handover has been successfully completed and the NCR device 706 has been handed over to the second network entity 704, the NCR device 706 may apply the second forwarding configuration for the target cell to forward signals for the target cell (e.g., to/from the second network entity 704 and/or UE 714). In this option, the second forwarding configuration may be received from the second network entity 704 after completion of the handover (e.g., similar to Option 1, above) or may be received in the HO command (e.g., similar to Option 2, above).

A fourth option (e.g., Option 4) may involve the NCR device 706 being configured to, upon receiving the HO command, stop the forwarding of unicast data signals received from the first network entity 702 while continuing to forward periodic or semi-persistent signals received from the first network entity 702 or the second network entity 704. For example, in some cases, the first forwarding configuration for the source cell may configure the NCR-FWD logical entity 716 to forward periodic signals associated with the source cell and/or the target cell. In this case, upon receiving the HO command, the NCR device 706 may stop the forwarding of unicast signals for the source cell, but may continue to forward the periodic signals for the source cell (e.g., received form the first network entity 702 and/or UE 714) and/or the target cell (e.g., received form the second network entity 704 and/or UE 714).

In other cases, in the fourth option, the first forwarding configuration for the source cell may configure the NCR-FWD logical entity 716 to forward semi-persistently scheduled signals associated with the source cell and/or the target cell. In some cases, prior to receiving the HO command, the NCR device 706 may receive an activation command for the first forwarding configuration form the first network entity 702. In such cases, upon receiving the HO command, the NCR device 706 may stop the forwarding of unicast signals for the source cell, but may continue to forward the semi-persistently scheduled signals for the source cell (e.g., received form the first network entity 702 and/or UE 714) and/or the target cell (e.g., received form the second network entity 704 and/or UE 714).

Thereafter, in Option 4, once the handover has been successfully completed and the NCR device 706 has been handed over to the second network entity 704, the NCR device 706 may apply the second forwarding configuration for the target cell to forward signals for the target cell (e.g., to/from the second network entity 704 and/or UE 714). In this option, the second forwarding configuration may be received from the second network entity 704 after completion of the handover (e.g., similar to Option 1, above) or may be received in the HO command (e.g., similar to Option 2, above).

A fifth option (Option 5) may involve the NCR device 706 receiving the second forwarding configuration for the target cell within the HO command received from the first network entity 702. The NCR-FWD logical entity 716 may then apply the second forwarding configuration received in the HO command and begin forwarding signals received by the NCR-FWD logical entity 716 in accordance with the second forwarding configuration, for example, during a handover procedure triggered by the HO command. In some cases, the second forwarding configuration may include a flag that indicates to the NCR device 706 whether or not to continue to forward signals during the handover procedure. The NCR-FWD logical entity 716 may then forward (or not forward) signals during the handover procedure based on the flag.

Additionally, the NCR device 706 may be configured to continue forwarding signals in accordance with the second forwarding configuration received in the HO command after completion of the handover of the NCR device 706 to the second network entity 704. In some cases, the NCR device 706 may receive a third forwarding configuration for the target cell from the second network entity for forwarding signals after completion of the handover.

In some cases, to support provisioning of the second forwarding configuration inside the HO command, the first network entity 702 associated with the source cell may indicate to the second network entity 704 associated with the target cell that the NCR device 706 that is to be handed over is a repeater device. In some cases, this indication may be provided, for example, within the handover request message shown in FIG. 5. The second network entity 704 may then generate the second forwarding configuration based on the indication that the NCR device 706 that is to be handed over is a repeater device. In some cases, the first network entity 702 may indicate to the second network entity 704 (e.g., in the handover request message shown in FIG. 5) the first forwarding configuration for the source cell used by the NCR device 706 while connected to the first network entity 702. In some cases, the second network entity 704 may generate the second forwarding configuration based on the first forwarding configuration (e.g., using delta signaling on top of the first forwarding configuration).

After generating/determining the second forwarding configuration, the second network entity 704 may transmit a handover request acknowledgement message to the first network entity 702 associated with the source cell approving the handover of the NCR device 706. In some cases, the handover request acknowledgement message may include an indication of a second forwarding configuration for the target cell. Thereafter, the first network entity 702 may transmit the HO command (e.g., RRCReconfiguration message in step 3 of FIG. 5) to the NCR device 706 indicating the second forwarding configuration.

In some cases, the first network entity comprises a first distributed unit (DU) associated with a central unit (CU) and the second network entity comprises a second DU associated with the CU. In such cases, the first network entity 702 and the second network entity 704 may communicate the handover request message and the handover request acknowledgement message to each other via the CU. For example, the first network entity 702 may transmit the handover request message from the first DU (e.g., first network entity 702) to the second DU (e.g., second network entity 704) via the CU. Similarly, the second network entity 704 may transmit the HO request acknowledgement message from the second DU (e.g., second network entity 704) to the first DU (e.g., first network entity 702) via the CU.

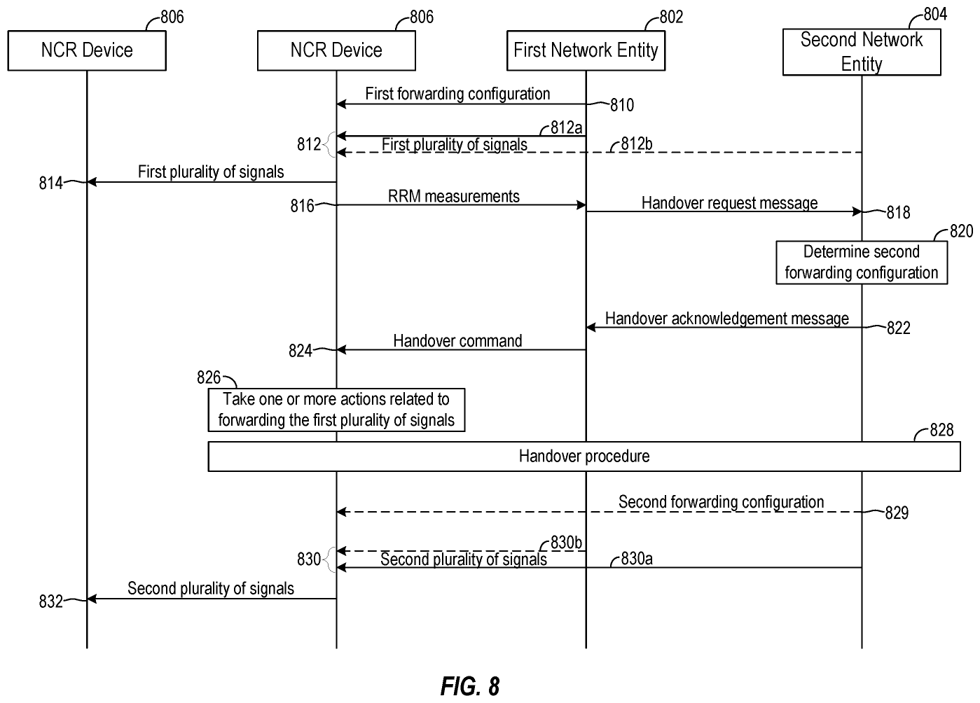

Additional details regarding the different options described above are provided below with respect to FIG. 8.

### Example Operations of Entities in a Communications Network

FIG. 8 depicts a process flow including operations 800 for communications in a network between a first network entity 802, a second network entity 804, an NCR device 806, and one or more UEs 808 for managing forwarding operations during repeater migration. In some aspects, the first network entity 802 may be an example of the BS 102 illustrated and described with respect to FIGS. 1 and 3, a disaggregated base station illustrated and described with respect to FIG. 2B, and/or the first network entity 702 illustrated and described with respect to FIGS. 7A, 7B, and 7C. In some aspects, the first network entity 802 may be associated with a source cell. In some aspects, the second network entity 804 may be an example of the BS 102 illustrated and described with respect to FIGS. 1 and 3, a disaggregated base station illustrated and described with respect to FIG. 2B, and/or the second network entity 704 illustrated and described with respect to FIGS. 7A, 7B, and 7C. In some aspects, the second network entity 804 may be associated with a target cell. In some aspects, the one or more UEs 808 may be an example of the UE 104 illustrated and described with respect to FIGS. 1 and 3.

As shown, operations 800 begin at 810 with the NCR device 806 receiving, from the first network entity 802 associated with the source cell, a first forwarding configuration for the source cell (e.g., for the NCR device 806 to use when connected to the source cell/first network entity 802) for configuring the NCR device 806 (e.g., the NCR-FWD logical entity 716 illustrated in FIG. 7B) to forward a first plurality of signals, received at the NCR device 706, to the one or more UEs 808.

In some cases, the first forwarding configuration may include an indication of a beam to use for forwarding signals on an access link (e.g., between the NCR device 806 and the one or more UEs 808) while in the source cell (e.g., a beam index of a communication beam for the access link, such as the access link 612 illustrated and described with respect to FIG. 6), an indication of a beam to use for forwarding signals on a backhaul link (e.g., between the first network entity 802 and the NCR device 806) while in the source cell (e.g., a beam index of a communication beam for the backhaul link, such as the access link 612 illustrated and described with respect to FIG. 6), an ON/OFF indication relating to a forwarding functionality of the NCR device 806, etc. Additional examples of information that may be included in the first forwarding configuration are described above with respect to FIG. 6.

In some aspects, the NCR device 806 may be an example of the NCR device 706 illustrated and described with respect to FIGS. 7A, 7B, and 7C. For example, in some cases, the NCR device 806 may include MT logical entity (e.g., NCR-MT logical entity 710 illustrated in FIGS. 7A and 7B) for the receiving of the first forwarding configuration from the first network entity 802 associated with the source cell. Additionally, in some cases, the NCR device 806 may include a forwarding logical entity (e.g., NCR-FWD logical entity 716 illustrated in FIGS. 7A and 7B) for the forwarding of the first plurality of signals to the one or more UEs in accordance with the first forwarding configuration for the source cell.

As shown at 812, the NCR device 806 receives the first plurality of signals. At 814, the NCR device 806 then forwards the first plurality of signals to the one or more UEs 808 in accordance with the first forwarding configuration for the source cell.

In some cases, to support mobility, the NCR device 806 may perform RRM measurements associated with one or more neighboring network entities, such as the second network entity 804. In some cases, the RRM measurements may be based on one or more reference signals transmitted by the one or more neighboring network entities, such as channel state information reference signals (CSI-RSs), synchronization signal blocks (SSBs), or other reference signals. As shown at 816, the NCR device 806 may transmit a measurement report to the first network entity 802 indicating the RRM measurements.

As shown at 818, the first network entity 802 may transmit a handover (HO) request message to the second network entity 804 associated with the target cell, requesting that the NCR device 806 be handed over to the second network entity 804 associated with the target cell. In some cases, the HO request message includes an indication that the NCR device is a repeater device. In some cases, the HO request message includes an indication of the first forwarding configuration.

As shown at 820, the second network entity 804 determines a second forwarding configuration for the target cell for configuring the NCR device 806 to forward a second plurality of signals, received at the NCR device 806, to the one or more UEs 808. In some cases, the second network entity 804 may determine the second forwarding configuration for the target cell based on the first forwarding configuration for the source cell indicated in the HO request message from the first network entity 802.

At 822, the second network entity 804 transmits a HO request acknowledgement message to the first network entity 802 associated with the source cell approving the handover of the NCR device 806. In some cases, the HO request acknowledgement message includes an indication of a second forwarding configuration for the target cell for configuring the NCR device 806 (e.g., the NCR-FWD logical entity 716 illustrated in FIGS. 7A and 7B) to forward a second plurality of signals, received at the NCR device 806, to the one or more UEs 808.

In some cases, the first network entity 802 comprises a first distributed unit (DU) associated with a central unit (CU). In some cases, the second network entity 804 comprises a second DU associated with the CU. In some cases, transmitting the HO request message to the second network entity 804 associated with the source cell at 818 may include transmitting the HO request message from the first DU to the second DU via the CU. Similarly, in some cases, transmitting the HO request acknowledgement message to the first network entity 802 associated with the source cell at 822 may include transmitting the HO request acknowledgement message from the second DU to the first DU via the CU

At 824, the NCR device 806 receives, from the first network entity 802, HO command (e.g., an RRCReconfiguration message) instructing the NCR device 806 to handover from the first network entity 802 associated with the source cell to the second network entity 804 associated with the target cell.

At 826, the NCR device 806 takes one or more actions related to the forwarding signals to the one or more UEs 808 in response to receiving the HO command.

In some cases, the first plurality of signals received by the NCR device 806 at 812 may comprise a first set of signals received from the first network entity 802, as shown at 812a. In some cases, the first set of signals received from the first network entity 802 at 812a may comprise (1) one or more periodic or semi-persistent signals received from the first network entity 802 and/or (2) one or more unicast data signals received from the first network entity 802. In some cases, the one or more periodic or semi-persistent signals received from the first network entity 802 comprise at least one or more SSBs received from the first network entity 802.

In some cases, taking the one or more actions at 826 comprises stopping the forwarding of the first set of signals received at 812a, of the first plurality of signals received at 812, to the one or more UEs 808 after receiving the HO command, for example, in accordance with Options 1-3 described above.

In some cases, the first plurality of signals may optionally include a second set of signals received from the second network entity 804, as shown at 812b. In some cases, the second set of signals received from the second network entity 804 at 812b may include one or more periodic or semi-persistent signals received from the second network entity 804. In such cases, taking the one or more actions at 826 comprises continuing to forward the second set of signals, received from the second network entity 804 at 812b, to the one or more UEs 808 after receiving the HO command. In some cases, the one or more periodic or semi-persistent signals received from the second network entity 804 comprise at least one or more SSBs received from the second network entity 804.

In some cases, taking the one or more actions at 826 may include stopping the forwarding of the one or more unicast data signals, received from the first network entity 802, to the one or more UEs 808 after receiving the HO command, for example, in accordance with Option 4 described above. In some cases taking the one or more actions further comprise, after receiving the HO command, continuing to forward the one or more periodic or semi-persistent signals received from the first network entity 802, to the one or more UEs 808, for example, in accordance with Option 4 described above. Additionally, in some cases, as noted above, the first plurality of signals comprises a second set of signals received from the second network entity 804 at 812b, which may include one or more periodic or semi-persistent signals received from the second network entity 804. In such cases, taking the one or more actions at 826 further comprise continuing to forward the second set of signals, received from the second network entity 804 at 812b, to the one or more UEs 808 after receiving the HO command, in accordance with Option 4 described above.

As shown at 828, the NCR device 806 may perform, based on the HO command, a HO procedure with the second network entity 804 associated with the target cell to handover the NCR device 806 to the second network entity 804.

In some cases, the NCR device 806 may receive the second forwarding configuration for the target cell (e.g., for the NCR device 806 to use when connected to the target cell/second network entity 804) for configuring the NCR device to forward a second plurality of signals, received at the NCR device 806, to the one or more UEs 808. As shown at 830, the NCR device 806 may receive, after completion of the HO procedure with the second network entity, the second plurality of signals. At 832, the NCR device 806 (e.g., via the NCR-FWD logical entity 716 illustrated in FIGS. 7A and 7B) may forward the second plurality of signals in accordance with the second forwarding configuration for the target cell to the one or more UEs 808. In some cases, the second plurality of signals may include a first set of signals received from the second network entity 804, such as SSBs received from the second network entity 804 and/or one or more unicast data signals received from the second network entity 804. In some cases, the second plurality of signals may also optionally include a second set of signals received from the first network entity 802, as illustrated at 830a, such as one or more SSBs received from the first network entity 802.

In some cases, the second forwarding configuration may include an indication of a beam to use for forwarding signals on an access link (e.g., between the NCR device 806 and the one or more UEs 808) while in the target cell (e.g., a beam index of a communication beam for the access link, such as the access link 612 illustrated and described with respect to FIG. 6), an indication of a beam to use for forwarding signals on a backhaul link (e.g., between the second network entity 804 and the NCR device 806) while in the target cell (e.g., a beam index of a communication beam for the backhaul link, such as the access link 612 illustrated and described with respect to FIG. 6), an ON/OFF indication relating to a forwarding functionality of the NCR device 806, etc. Additional examples of information that may be included in the second forwarding configuration are described above with respect to FIG. 6.

In some cases, the NCR device 706 may receive the second forwarding configuration for the target cell in the HO command, in accordance with Option 1 described above. In this case, the receiving at 830 and the forwarding of the second plurality of signals at 832 may performed upon completion of the HO procedure with the second network entity 804, for example, shortening a transient time associated with the HO procedure.

In some cases, as shown at 829, the NCR device 806 may receive a message from the second network entity 804, including the second forwarding configuration for the target cell, after completion of the HO procedure with the second network entity 804, in accordance with Option 2 described above. In this case, the receiving at 830 and the forwarding of the second plurality of signals at 832 may be performed after receiving the message from the second network entity 804 including the second forwarding configuration for the target cell.

In some cases, HO command received by the NCR device 806 at 824 may include a third forwarding configuration for forwarding the first plurality of signals to the one or more UEs during the HO procedure at 828 involving the handover of the NCR device 806 to the second network entity 804. In this case, the NCR device 806 may take the one or more actions at 826 during the HO procedure based on the third forwarding configuration, in accordance with Option 5 described above. For example, during the HO procedure, the NCR device 806 may continue to receive and forward the first plurality of signals to the one or more UEs 808 in accordance with the third forwarding configuration indicated in the HO command.

In some cases, continuing to receive and forward the first plurality of signals to the one or more UEs 808 may include continuing to receive the first plurality of signals received from the first network entity 802 and forward the first plurality of signals to the one or more UEs 808. In some cases, continuing to receive and forward the first plurality of signals to the one or more UEs 808 may include continuing to receive the first plurality of signals received from the second network entity 804 and forward the first plurality of signals to the one or more UEs 808. In some cases, continuing to receive and forward the first plurality of signals to the one or more UEs 808 may include refraining from forwarding the first plurality of signals received from the first network entity 802 while continuing to receive the first plurality of signals received from the second network entity 804 and forward the first plurality of signals from the second network entity 804 to the one or more UEs 808.

In some cases, as described above with respect to Option 5, the third forwarding configuration includes a flag that indicates to the NCR device 806 whether or not to continue to forward the first plurality of signals during the HO procedure. In this case, taking the one or more actions at 828 (e.g., to receive and forward the first plurality of signals in accordance with the third forwarding configuration) may include taking the one or more actions in accordance with the flag that indicates whether or not to continue to forward the first plurality of signals during the HO procedure. For example, if the flag indicates an OFF state for the NCR device 806 (e.g., for the NCR-FWD logical entity 716 illustrated in FIGS. 7A and 7B), the NCR device 806 may refrain from forwarding the first plurality of signals to the one or more UEs 808. Alternatively, if the flag indicates and ON state for the NCR device 806 (e.g., for the NCR-FWD logical entity 716 illustrated in FIGS. 7A and 7B), the NCR device 806 may continue to forwarding the first plurality of signals to the one or more UEs 808 in accordance with the third forwarding configuration (e.g., beam index, time resources, spatial direction, etc.).

Additionally, in accordance with Option 5 described above, in some cases, after completion of the HO procedure, the NCR device 806 may be configured to continue to use the third forwarding configuration indicated in the HO command. For example, the receiving at 830 and the forwarding of the second plurality of signals at 832 to the one or more UEs 808 after completion of the HO procedure may be performed in accordance with the third forwarding configuration indicated in the HO command. In some cases, however, the NCR device 806 may receive, from the second network entity 804, a fourth forwarding configuration for forwarding the second plurality of signals to the one or more UEs 808 after completion of the HO procedure. For example, the message indicating the second forwarding configuration at 829 may be the fourth forwarding configuration. In this case, the receiving at 830 and the forwarding of the second plurality of signals at 832 to the one or more UEs 808 after completion of the HO procedure may be based or performed in accordance with the fourth forwarding configuration.

### Example Operations of a Network-Controlled Repeater Device

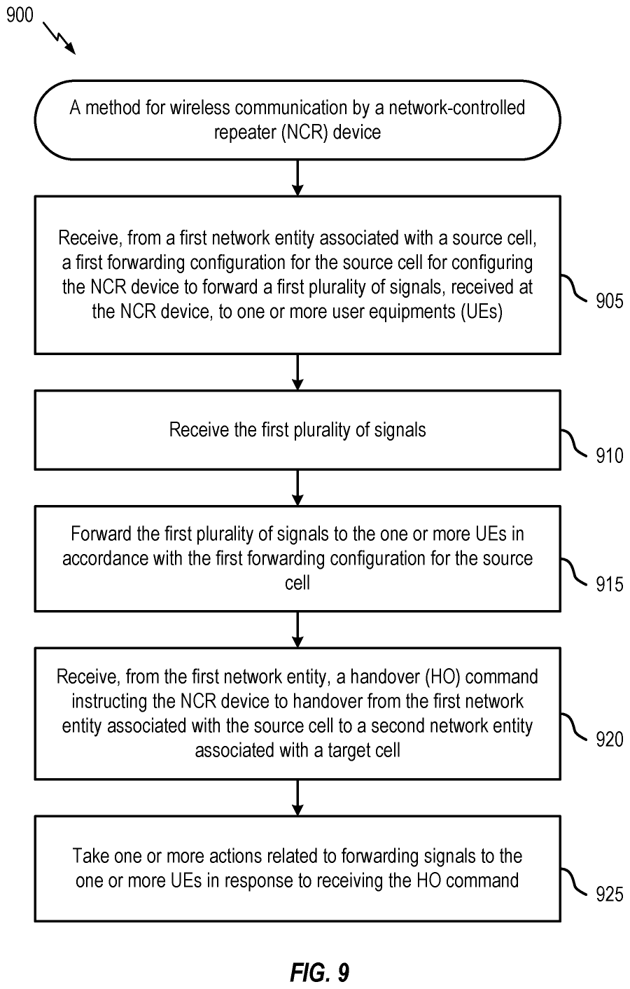

FIG. 9 shows an example of a method 900 of wireless communication by a network-controlled repeater (NCR) device, such as the NCR device 600 illustrated and described with respect to FIG. 6, the NCR device 700 illustrated and described with respect to FIG. 7, and/or the NCR device 806 illustrated and described with respect to FIG. 8.

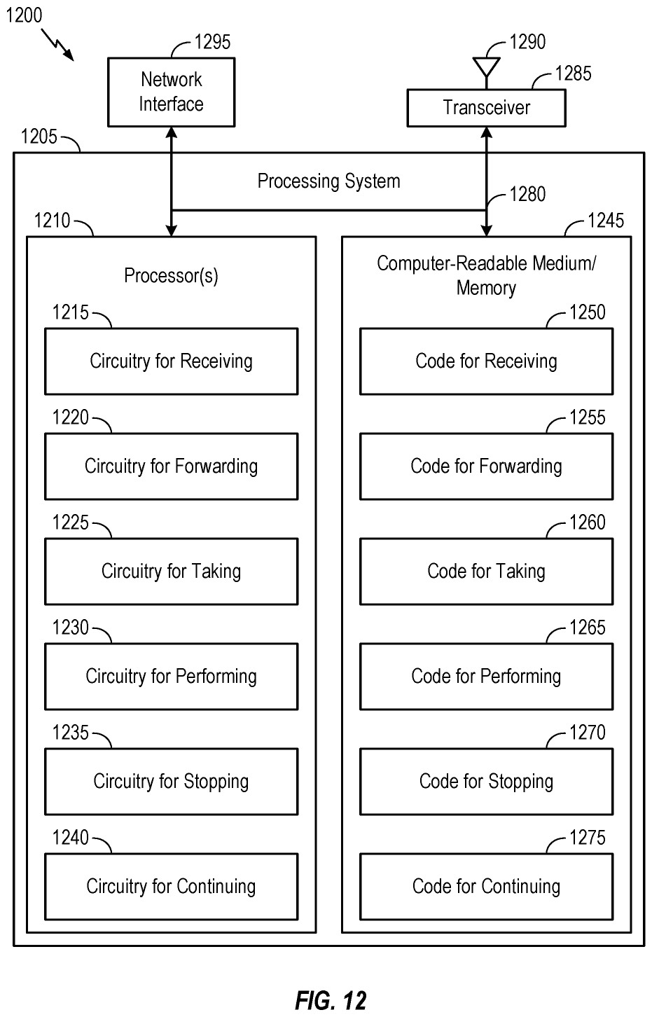

Method 900 begins at step 905 with receiving, from a first network entity associated with a source cell, a first forwarding configuration for the source cell for configuring the NCR device to forward a first plurality of signals, received at the NCR device, to one or more user equipments (UEs). In some cases, the operations of this step refer to, or may be performed by, circuitry for receiving and/or code for receiving as described with reference to FIG. 12.

Method 900 then proceeds to step 910 with receiving the first plurality of signals. In some cases, the operations of this step refer to, or may be performed by, circuitry for receiving and/or code for receiving as described with reference to FIG. 12.

Method 900 then proceeds to step 915 with forwarding the first plurality of signals to the one or more UEs in accordance with the first forwarding configuration for the source cell. In some cases, the operations of this step refer to, or may be performed by, circuitry for forwarding and/or code for forwarding as described with reference to FIG. 12.

Method 900 then proceeds to step 920 with receiving, from the first network entity, a handover (HO) command instructing the NCR device to handover from the first network entity associated with the source cell to a second network entity associated with a target cell. In some cases, the operations of this step refer to, or may be performed by, circuitry for receiving and/or code for receiving as described with reference to FIG. 12.

Method 900 then proceeds to step 925 with taking one or more actions related to forwarding signals to the one or more UEs in response to receiving the HO command. In some cases, the operations of this step refer to, or may be performed by, circuitry for taking and/or code for taking as described with reference to FIG. 12.

In some aspects, the method 900 further includes receiving a second forwarding configuration for the target cell for configuring the NCR device to forward a second plurality of signals, received at the NCR device, to the one or more UEs. In some cases, the operations of this step refer to, or may be performed by, circuitry for receiving and/or code for receiving as described with reference to FIG. 12.

In some aspects, the method 900 further includes performing, based on the HO command, a HO procedure with the second network entity associated with the target cell to handover the NCR device to the second network entity. In some cases, the operations of this step refer to, or may be performed by, circuitry for performing and/or code for performing as described with reference to FIG. 12.

In some aspects, the method 900 further includes receiving, after completion of the HO procedure with the second network entity, the second plurality of signals. In some cases, the operations of this step refer to, or may be performed by, circuitry for receiving and/or code for receiving as described with reference to FIG. 12.

In some aspects, the method 900 further includes forwarding the second plurality of signals in accordance with the second forwarding configuration for the target cell. In some cases, the operations of this step refer to, or may be performed by, circuitry for forwarding and/or code for forwarding as described with reference to FIG. 12.

In some aspects, the second plurality of signals comprise one or more synchronization signal blocks (SSBs) received from the first network entity; one or more SSBs received from the second network entity; and one or more unicast data signals received from the second network entity.

In some aspects, receiving the second forwarding configuration for the target cell comprises receiving the second forwarding configuration for the target cell in the HO command; and the receiving and the forwarding of the second plurality of signals is performed upon completion of the HO procedure with the second network entity.

In some aspects, receiving the second forwarding configuration for the target cell comprises receiving a message from the second network entity, including the second forwarding configuration for the target cell, after completion of the HO procedure with the second network entity; and the receiving and the forwarding of the second plurality of signals is performed after receiving the message from the second network entity including the second forwarding configuration for the target cell.

In some aspects, the first plurality of signals comprises a first set of signals received from the first network entity; and the first set of signals received from the first network entity comprises: one or more periodic or semi-persistent signals received from the first network entity; and one or more unicast data signals received from the first network entity.

In some aspects, the one or more periodic or semi-persistent signals received from the first network entity comprise at least one or more synchronization signal blocks (SSBs) received from the first network entity.

In some aspects, taking the one or more actions comprises stopping the forwarding of the first set of signals, of the first plurality of signals, to the one or more UEs after receiving the HO command.

In some aspects, the first plurality of signals comprises a second set of signals received from the second network entity; and the second set of signals received from the second network entity comprises one or more periodic or semi-persistent signals received from the second network entity; and taking the one or more actions comprises continuing to forward the second set of signals, received from the second network entity, to the one or more UEs after receiving the HO command.

In some aspects, the one or more periodic or semi-persistent signals received from the second network entity comprise at least one or more synchronization signal blocks (SSBs) received from the second network entity.

In some aspects, taking the one or more actions comprises stopping the forwarding of the one or more unicast data signals, received from the first network entity, to the one or more UEs after receiving the HO command.

In some aspects, taking the one or more actions further comprise, after receiving the HO command, continuing to forward the one or more periodic or semi-persistent signals received from the first network entity, to the one or more UEs.

In some aspects, the first plurality of signals comprises a second set of signals received from the second network entity; and the second set of signals received from the second network entity comprises one or more periodic or semi-persistent signals received from the second network entity; and taking the one or more actions further comprise continuing to forward the second set of signals, received from the second network entity, to the one or more UEs after receiving the HO command.

In some aspects, the HO command includes a second forwarding configuration for forwarding the first plurality of signals to the one or more UEs during a HO procedure involving a handover of the NCR device to the second network entity.

In some aspects, the method 900 further includes performing the HO procedure based on the HO command. In some cases, the operations of this step refer to, or may be performed by, circuitry for performing and/or code for performing as described with reference to FIG. 12.

In some aspects, taking the one or more actions comprises taking the one or more actions during the HO procedure based on the second forwarding configuration.

In some aspects, the second forwarding configuration includes a flag that indicates to the NCR device whether or not to continue to forward the first plurality of signals during the HO procedure; and taking the one or more actions comprises taking the one or more actions in accordance with the flag that indicates whether or not to continue to forward the first plurality of signals during the HO procedure.

In some aspects, the method 900 further includes receiving and forwarding a second plurality of signals to the one or more UEs after completion of the HO procedure based on the second forwarding configuration. In some cases, the operations of this step refer to, or may be performed by, circuitry for receiving and/or code for receiving as described with reference to FIG. 12.

In some aspects, the method 900 further includes receiving, from the second network entity, a third forwarding configuration for forwarding a second plurality of signals to the one or more UEs after completion of the HO procedure. In some cases, the operations of this step refer to, or may be performed by, circuitry for receiving and/or code for receiving as described with reference to FIG. 12.

In some aspects, the method 900 further includes receiving and forwarding the second plurality of signals to the one or more UEs after completion of the HO procedure based on the third forwarding configuration. In some cases, the operations of this step refer to, or may be performed by, circuitry for receiving and/or code for receiving as described with reference to FIG. 12.

In some aspects, the NCR device comprises: a mobile termination (MT) logical entity for the receiving of the first forwarding configuration from the first network entity associated with the source cell; and a forwarding logical entity for the forwarding of the first plurality of signals to the one or more UEs in accordance with the first forwarding configuration for the source cell.

In one aspect, method 900, or any aspect related to it, may be performed by an apparatus, such as communications device 1200 of FIG. 12, which includes various components operable, configured, or adapted to perform the method 900. Communications device 1200 is described below in further detail.

Note that FIG. 9 is just one example of a method, and other methods including fewer, additional, or alternative steps are possible consistent with this disclosure.

### Example Operations of a First Network Entity

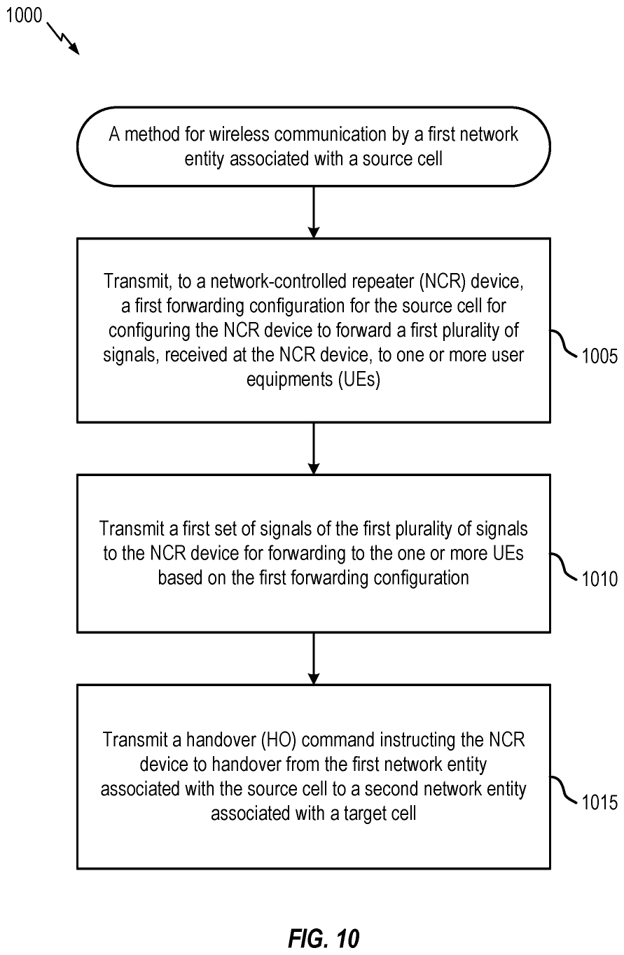

FIG. 10 shows an example of a method 1000 of wireless communication by a first network entity associated with a source cell, such as a BS 102 of FIGS. 1 and 3, or a disaggregated base station as discussed with respect to FIG. 2.

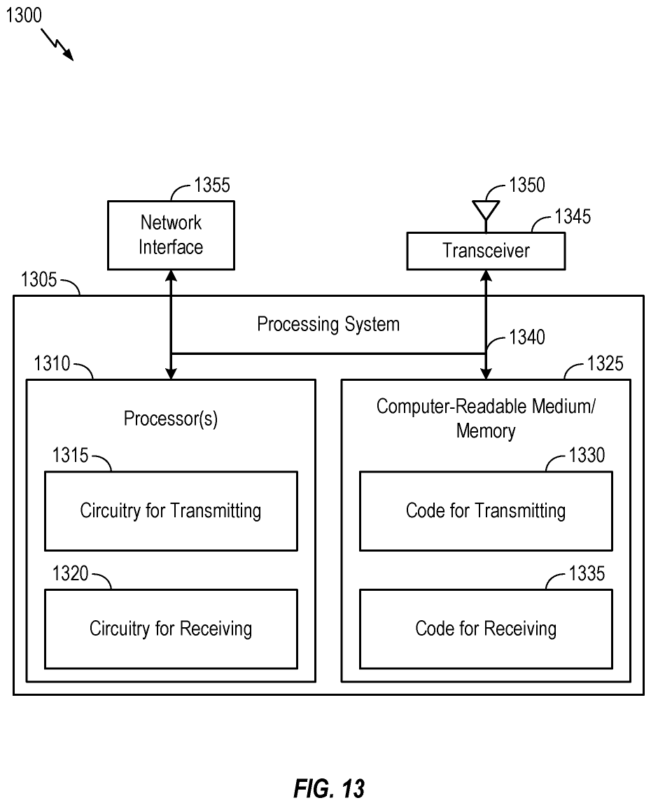

Method 1000 begins at step 1005 with transmitting, to a network-controlled repeater (NCR) device, a first forwarding configuration for the source cell for configuring the NCR device to forward a first plurality of signals, received at the NCR device, to one or more user equipments (UEs). In some cases, the operations of this step refer to, or may be performed by, circuitry for transmitting and/or code for transmitting as described with reference to FIG. 13.

Method 1000 then proceeds to step 1010 with transmitting a first set of signals of the first plurality of signals to the NCR device for forwarding to the one or more UEs based on the first forwarding configuration. In some cases, the operations of this step refer to, or may be performed by, circuitry for transmitting and/or code for transmitting as described with reference to FIG. 13.

Method 1000 then proceeds to step 1015 with transmitting a handover (HO) command instructing the NCR device to handover from the first network entity associated with the source cell to a second network entity associated with a target cell. In some cases, the operations of this step refer to, or may be performed by, circuitry for transmitting and/or code for transmitting as described with reference to FIG. 13.

In some aspects, the method 1000 further includes transmitting, prior to transmitting the HO command to the NCR device, a HO request message to the second network entity associated with the target cell, requesting that the NCR device be handed over to the second network entity associated with the target cell. In some cases, the operations of this step refer to, or may be performed by, circuitry for transmitting and/or code for transmitting as described with reference to FIG. 13.

In some aspects, the HO request message includes an indication that the NCR device is a repeater device.

In some aspects, the HO request message includes an indication of the first forwarding configuration.

In some aspects, the method 1000 further includes receiving a HO request acknowledgement message from the second network entity associated with the target cell approving the handover of the NCR device. In some cases, the operations of this step refer to, or may be performed by, circuitry for receiving and/or code for receiving as described with reference to FIG. 13.

In some aspects, the HO request acknowledgement message includes an indication of a second forwarding configuration for the target cell for configuring the NCR device to forward a second plurality of signals, received at the NCR device, to the one or more UEs.

In some aspects, transmitting the HO command to the NCR device is based on the HO request acknowledgement message received from the second network entity associated with the target cell; and the HO command includes the indication of the second forwarding configuration for the target cell.

In some aspects, the first network entity comprises a first distributed unit (DU) associated with a central unit (CU); and the second network entity comprises a second DU associated with the CU.

In some aspects, transmitting the HO request message to the second network entity associated with the source cell comprises transmitting the HO request message from the first DU to the second DU via the CU.

In some aspects, receiving the HO request acknowledgement message from the second network entity associated with the source cell comprises receiving the HO request acknowledgement message from the second DU via the CU.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

### Example Operations of a Second Network Entity

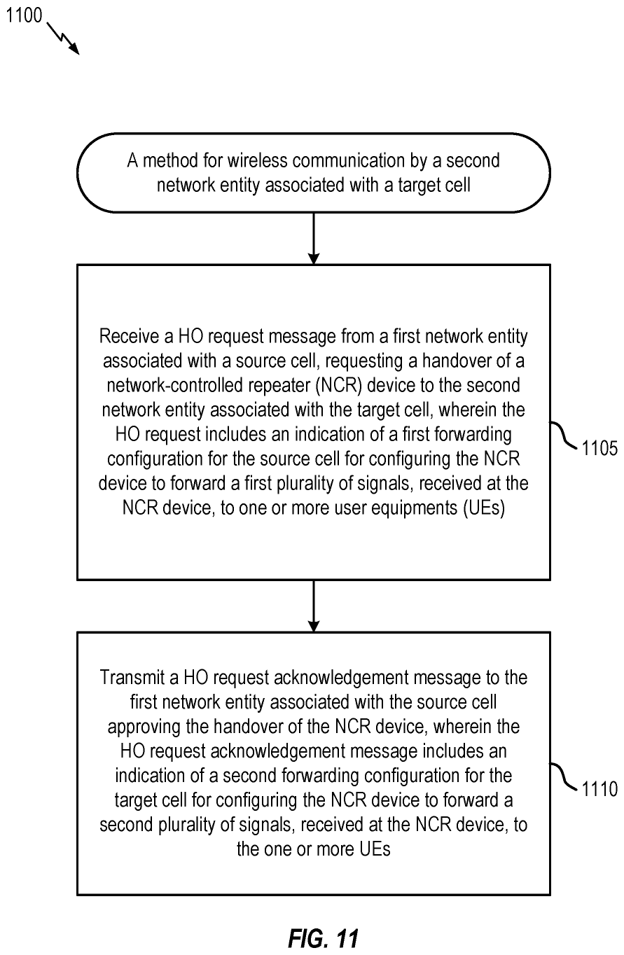

FIG. 11 shows an example of a method 1100 of wireless communication by a second network entity associated with a target cell, such as a BS 102 of FIGS. 1 and 3, or a disaggregated base station as discussed with respect to FIG. 2.

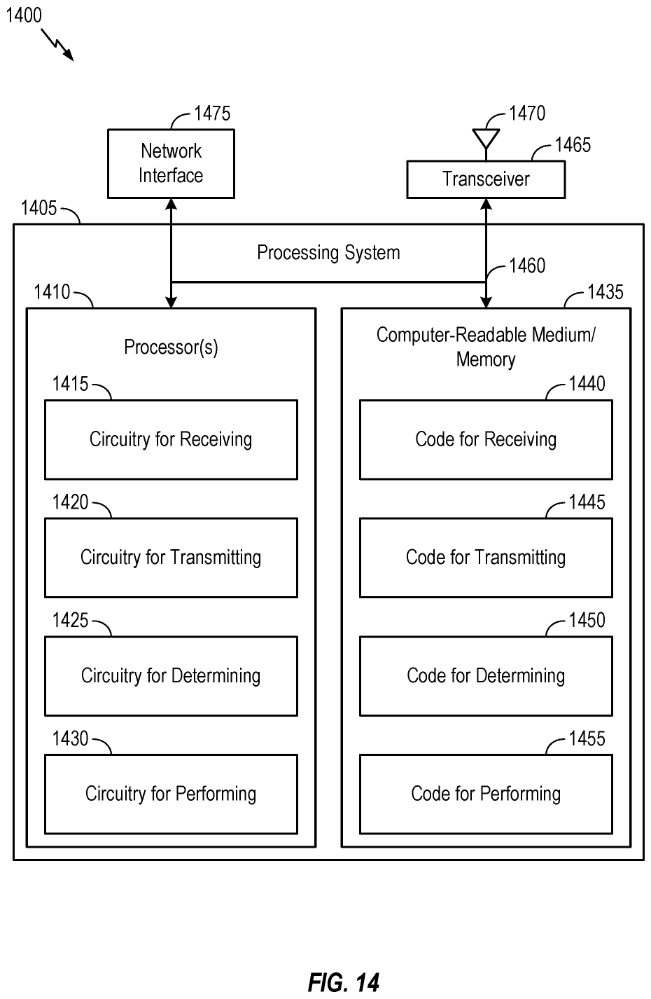

Method 1100 begins at step 1105 with receiving a HO request message from a first network entity associated with a source cell, requesting a handover of a network-controlled repeater (NCR) device to the second network entity associated with the target cell, wherein the HO request includes an indication of a first forwarding configuration for the source cell for configuring the NCR device to forward a first plurality of signals, received at the NCR device, to one or more user equipments (UEs). In some cases, the operations of this step refer to, or may be performed by, circuitry for receiving and/or code for receiving as described with reference to FIG. 14.

Method 1100 then proceeds to step 1110 with transmitting a HO request acknowledgement message to the first network entity associated with the source cell approving the handover of the NCR device, wherein the HO request acknowledgement message includes an indication of a second forwarding configuration for the target cell for configuring the NCR device to forward a second plurality of signals, received at the NCR device, to the one or more UEs. In some cases, the operations of this step refer to, or may be performed by, circuitry for transmitting and/or code for transmitting as described with reference to FIG. 14.

In some aspects, the first network entity comprises a first distributed unit (DU) associated with a central unit (CU); and the second network entity comprises a second DU associated with the CU.

In some aspects, receiving the HO request message from the first network entity associated with the source cell comprises receiving the HO request message from the first DU via the CU.

In some aspects, transmitting the HO request acknowledgement message to the first network entity associated with the source cell comprises transmitting the HO request acknowledgement message from the second DU to the first DU via the CU.

In some aspects, the HO request includes an indication that the NCR device is a repeater device.

In some aspects, the method 1100 further includes determining the second forwarding configuration for the target cell based on the first forwarding configuration for the source cell. In some cases, the operations of this step refer to, or may be performed by, circuitry for determining and/or code for determining as described with reference to FIG. 14.

In some aspects, the method 1100 further includes performing a HO procedure with the NCR device to handover the NCR device to the second network entity associated with the target cell. In some cases, the operations of this step refer to, or may be performed by, circuitry for performing and/or code for performing as described with reference to FIG. 14.

In some aspects, the method 1100 further includes transmitting a first set of signals of the second plurality of signals to the NCR device for forwarding to the one or more UEs based on the second forwarding configuration. In some cases, the operations of this step refer to, or may be performed by, circuitry for transmitting and/or code for transmitting as described with reference to FIG. 14.

In some aspects, the method 1100 further includes transmitting, to the NCR device, a third forwarding configuration for forwarding the second plurality of signals to the one or more UEs after completion of the HO procedure. In some cases, the operations of this step refer to, or may be performed by, circuitry for transmitting and/or code for transmitting as described with reference to FIG. 14.

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

### Example Communications Devices

FIG. 12 depicts aspects of an example communications device 1200. In some aspects, communications device 1200 is a network entity, such as a network-controlled repeater (NCR) device. For example, in some cases, the communications device 1200 may be an example of the NCR device 600 illustrated and described with respect to FIG. 6, the NCR device 700 illustrated and described with respect to FIG. 7, and/or the NCR device 806 illustrated and described with respect to FIG. 8.

The communications device 1200 includes a processing system 1205 coupled to the transceiver 1285 (e.g., a transmitter and/or a receiver) and/or a network interface 1295. The transceiver 1285 is configured to transmit and receive signals for the communications device 1200 via the antenna 1290, such as the various signals as described herein. The network interface 1295 is configured to obtain and send signals for the communications device 1200 via communication link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. In some cases, the one or more processors may be configured to implement one or more logical entities of an NCR device, such as the NCR-MT logical entity 710 and NCR-FWD logical entity 608 of the NCR device 600 illustrated in and described with respect to FIG. 6 and/or the NCR-MT logical entity 710 and the NCR-FWD logical entity 716 of the NCR device 706 illustrated in and described with respect to FIG. 7.

As shown, the one or more processors 1210 are coupled to a computer-readable medium/memory 1245 via a bus 1280. In certain aspects, the computer-readable medium/memory 1245 is configured to store instructions (e.g., computer-executable code) that when executed by the one or more processors 1210, cause the one or more processors 1210 to perform the method 900 described with respect to FIG. 9, or any aspect related to it. Note that reference to a processor of communications device 1200 performing a function may include one or more processors 1210 of communications device 1200 performing that function.

In the depicted example, the computer-readable medium/memory 1245 stores code (e.g., executable instructions), such as code for receiving 1250, code for forwarding 1255, code for taking 1260, code for performing 1265, code for stopping 1270, and code for continuing 1275. Processing of the code for receiving 1250, code for forwarding 1255, code for taking 1260, code for performing 1265, code for stopping 1270, and code for continuing 1275 may cause the communications device 1200 to perform the method 900 described with respect to FIG. 9, or any aspect related to it.

The one or more processors 1210 include circuitry configured to implement (e.g., execute) the code stored in the computer-readable medium/memory 1245, including circuitry such as circuitry for receiving 1215, circuitry for forwarding 1220, circuitry for taking 1225, circuitry for performing 1230, circuitry for stopping 1235, and circuitry for continuing 1240. Processing with circuitry for receiving 1215, circuitry for forwarding 1220, circuitry for taking 1225, circuitry for performing 1230, circuitry for stopping 1235, and circuitry for continuing 1240 may cause the communications device 1200 to perform the method 900 described with respect to FIG. 9, or any aspect related to it.

Various components of the communications device 1200 may provide means for performing the method 900 described with respect to FIG. 9, or any aspect related to it. Means for transmitting, sending or outputting for transmission may include transceivers 332 and/or antenna(s) 334 of the BS 102 illustrated in FIG. 3 and/or the transceiver 1285 and the antenna 1290 of the communications device 1200 in FIG. 12. Means for receiving or obtaining may include transceivers 332 and/or antenna(s) 334 of the BS 102 illustrated in FIG. 3 and/or the transceiver 1285 and the antenna 1290 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to the transceiver 1345 (e.g., a transmitter and/or a receiver) and/or a network interface 1355. The transceiver 1345 is configured to transmit and receive signals for the communications device 1300 via the antenna 1350, such as the various signals as described herein. The network interface 1355 is configured to obtain and send signals for the communications device 1300 via communication link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1325 via a bus 1340. In certain aspects, the computer-readable medium/memory 1325 is configured to store instructions (e.g., computer-executable code) that when executed by the one or more processors 1310, cause the one or more processors 1310 to perform the method 1000 described with respect to FIG. 10, or any aspect related to it. Note that reference to a processor of communications device 1300 performing a function may include one or more processors 1310 of communications device 1300 performing that function.

In the depicted example, the computer-readable medium/memory 1325 stores code (e.g., executable instructions), such as code for transmitting 1330 and code for receiving 1335. Processing of the code for transmitting 1330 and code for receiving 1335 may cause the communications device 1300 to perform the method 1000 described with respect to FIG. 10, or any aspect related to it.

The one or more processors 1310 include circuitry configured to implement (e.g., execute) the code stored in the computer-readable medium/memory 1325, including circuitry such as circuitry for transmitting 1315 and circuitry for receiving 1320. Processing with circuitry for transmitting 1315 and circuitry for receiving 1320 may cause the communications device 1300 to perform the method 1000 described with respect to FIG. 10, or any aspect related to it.

Various components of the communications device 1300 may provide means for performing the method 1000 described with respect to FIG. 10, or any aspect related to it. Means for transmitting, sending or outputting for transmission may include transceivers 332 and/or antenna(s) 334 of the BS 102 illustrated in FIG. 3 and/or the transceiver 1345 and the antenna 1350 of the communications device 1300 in FIG. 13. Means for receiving or obtaining may include transceivers 332 and/or antenna(s) 334 of the BS 102 illustrated in FIG. 3 and/or the transceiver 1345 and the antenna 1350 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1465 (e.g., a transmitter and/or a receiver) and/or a network interface 1475. The transceiver 1465 is configured to transmit and receive signals for the communications device 1400 via the antenna 1470, such as the various signals as described herein. The network interface 1475 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1435 via a bus 1460. In certain aspects, the computer-readable medium/memory 1435 is configured to store instructions (e.g., computer-executable code) that when executed by the one or more processors 1410, cause the one or more processors 1410 to perform the method 1100 described with respect to FIG. 11, or any aspect related to it. Note that reference to a processor of communications device 1400 performing a function may include one or more processors 1410 of communications device 1400 performing that function.

In the depicted example, the computer-readable medium/memory 1435 stores code (e.g., executable instructions), such as code for receiving 1440, code for transmitting 1445, code for determining 1450, and code for performing 1455. Processing of the code for receiving 1440, code for transmitting 1445, code for determining 1450, and code for performing 1455 may cause the communications device 1400 to perform the method 1100 described with respect to FIG. 11, or any aspect related to it.

The one or more processors 1410 include circuitry configured to implement (e.g., execute) the code stored in the computer-readable medium/memory 1435, including circuitry such as circuitry for receiving 1415, circuitry for transmitting 1420, circuitry for determining 1425, and circuitry for performing 1430. Processing with circuitry for receiving 1415, circuitry for transmitting 1420, circuitry for determining 1425, and circuitry for performing 1430 may cause the communications device 1400 to perform the method 1100 described with respect to FIG. 11, or any aspect related to it.

Various components of the communications device 1400 may provide means for performing the method 1100 described with respect to FIG. 11, or any aspect related to it. Means for transmitting, sending or outputting for transmission may include transceivers 332 and/or antenna(s) 334 of the BS 102 illustrated in FIG. 3 and/or the transceiver 1465 and the antenna 1470 of the communications device 1400 in FIG. 14. Means for receiving or obtaining may include transceivers 332 and/or antenna(s) 334 of the BS 102 illustrated in FIG. 3 and/or the transceiver 1465 and the antenna 1470 of the communications device 1400 in FIG. 14.

### Example Clauses

Implementation examples are described in the following numbered clauses:

Clause 1: A method for wireless communication by a network-controlled repeater (NCR) device, comprising: receiving, from a first network entity associated with a source cell, a first forwarding configuration for the source cell for configuring the NCR device to forward a first plurality of signals, received at the NCR device, to one or more user equipments (UEs); receiving the first plurality of signals; forwarding the first plurality of signals to the one or more UEs in accordance with the first forwarding configuration for the source cell; receiving, from the first network entity, a handover (HO) command instructing the NCR device to handover from the first network entity associated with the source cell to a second network entity associated with a target cell; and taking one or more actions related to forwarding signals to the one or more UEs in response to receiving the HO command.

Clause 2: The method of Clause 1, further comprising receiving a second forwarding configuration for the target cell for configuring the NCR device to forward a second plurality of signals, received at the NCR device, to the one or more UEs.

Clause 3: The method of Clause 2, further comprising performing, based on the HO command, a HO procedure with the second network entity associated with the target cell to handover the NCR device to the second network entity.

Clause 4: The method of Clause 3, further comprising: receiving, after completion of the HO procedure with the second network entity, the second plurality of signals; and forwarding the second plurality of signals in accordance with the second forwarding configuration for the target cell.

Clause 5: The method of Clause 4, wherein the second plurality of signals comprise: one or more synchronization signal blocks (SSBs) received from the first network entity; one or more SSBs received from the second network entity; and one or more unicast data signals received from the second network entity.

Clause 6: The method of Clause 4, wherein: receiving the second forwarding configuration for the target cell comprises receiving the second forwarding configuration for the target cell in the HO command; and the receiving and the forwarding of the second plurality of signals is performed upon completion of the HO procedure with the second network entity.

Clause 7: The method of Clause 4, wherein: receiving the second forwarding configuration for the target cell comprises receiving a message from the second network entity, including the second forwarding configuration for the target cell, after completion of the HO procedure with the second network entity; and the receiving and the forwarding of the second plurality of signals is performed after receiving the message from the second network entity including the second forwarding configuration for the target cell.

Clause 8: The method of Clause 4, wherein: the first plurality of signals comprises a first set of signals received from the first network entity; and the first set of signals received from the first network entity comprises: one or more periodic or semi-persistent signals received from the first network entity; and one or more unicast data signals received from the first network entity.

Clause 9: The method of Clause 8, wherein the one or more periodic or semi-persistent signals received from the first network entity comprise at least one or more synchronization signal blocks (SSBs) received from the first network entity.

Clause 10: The method of Clause 8, wherein taking the one or more actions comprises stopping the forwarding of the first set of signals, of the first plurality of signals, to the one or more UEs after receiving the HO command.

Clause 11: The method of Clause 10, wherein: the first plurality of signals comprises a second set of signals received from the second network entity; and the second set of signals received from the second network entity comprises one or more periodic or semi-persistent signals received from the second network entity; and taking the one or more actions comprises continuing to forward the second set of signals, received from the second network entity, to the one or more UEs after receiving the HO command.

Clause 12: The method of Clause 11, wherein the one or more periodic or semi-persistent signals received from the second network entity comprise at least one or more synchronization signal blocks (SSBs) received from the second network entity.

Clause 13: The method of Clause 10, wherein taking the one or more actions comprises stopping the forwarding of the one or more unicast data signals, received from the first network entity, to the one or more UEs after receiving the HO command.

Clause 14: The method of Clause 13, wherein taking the one or more actions further comprise, after receiving the HO command, continuing to forward the one or more periodic or semi-persistent signals received from the first network entity, to the one or more UEs.

Clause 15: The method of Clause 13, wherein: the first plurality of signals comprises a second set of signals received from the second network entity; and the second set of signals received from the second network entity comprises one or more periodic or semi-persistent signals received from the second network entity; and taking the one or more actions further comprise continuing to forward the second set of signals, received from the second network entity, to the one or more UEs after receiving the HO command.

Clause 16: The method of any one of Clauses 1-15, wherein the HO command includes a second forwarding configuration for forwarding the first plurality of signals to the one or more UEs during a HO procedure involving a handover of the NCR device to the second network entity.

Clause 17: The method of Clause 16, further comprising performing the HO procedure based on the HO command.

Clause 18: The method of Clause 17, wherein taking the one or more actions comprises taking the one or more actions during the HO procedure based on the second forwarding configuration.

Clause 19: The method of Clause 18, wherein: the second forwarding configuration includes a flag that indicates to the NCR device whether or not to continue to forward the first plurality of signals during the HO procedure; and taking the one or more actions comprises taking the one or more actions in accordance with the flag that indicates whether or not to continue to forward the first plurality of signals during the HO procedure.

Clause 20: The method of Clause 18, further comprising receiving and forwarding a second plurality of signals to the one or more UEs after completion of the HO procedure based on the second forwarding configuration.

Clause 21: The method of Clause 18, further comprising: receiving, from the second network entity, a third forwarding configuration for forwarding a second plurality of signals to the one or more UEs after completion of the HO procedure; and receiving and forwarding the second plurality of signals to the one or more UEs after completion of the HO procedure based on the third forwarding configuration.

Clause 22: The method of any one of Clauses 1-21, wherein the NCR device comprises: a mobile termination (MT) logical entity for the receiving of the first forwarding configuration from the first network entity associated with the source cell; and a forwarding logical entity for the forwarding of the first plurality of signals to the one or more UEs in accordance with the first forwarding configuration for the source cell.

Clause 23: A method for wireless communication by a first network entity associated with a source cell, comprising: transmitting, to a network-controlled repeater (NCR) device, a first forwarding configuration for the source cell for configuring the NCR device to forward a first plurality of signals, received at the NCR device, to one or more user equipments (UEs); transmitting a first set of signals of the first plurality of signals to the NCR device for forwarding to the one or more UEs based on the first forwarding configuration; and transmitting a handover (HO) command instructing the NCR device to handover from the first network entity associated with the source cell to a second network entity associated with a target cell.

Clause 24: The method of Clause 23, further comprising transmitting, prior to transmitting the HO command to the NCR device, a HO request message to the second network entity associated with the target cell, requesting that the NCR device be handed over to the second network entity associated with the target cell.

Clause 25: The method of Clause 24, wherein the HO request message includes an indication that the NCR device is a repeater device.

Clause 26: The method of Clause 24, wherein the HO request message includes an indication of the first forwarding configuration.

Clause 27: The method of Clause 24, further comprising receiving a HO request acknowledgement message from the second network entity associated with the target cell approving the handover of the NCR device.

Clause 28: The method of Clause 27, wherein the HO request acknowledgement message includes an indication of a second forwarding configuration for the target cell for configuring the NCR device to forward a second plurality of signals, received at the NCR device, to the one or more UEs.

Clause 29: The method of Clause 28, wherein: transmitting the HO command to the NCR device is based on the HO request acknowledgement message received from the second network entity associated with the target cell; and the HO command includes the indication of the second forwarding configuration for the target cell.

Clause 30: The method of Clause 27, wherein: the first network entity comprises a first distributed unit (DU) associated with a central unit (CU); and the second network entity comprises a second DU associated with the CU.

Clause 31: The method of Clause 30, wherein transmitting the HO request message to the second network entity associated with the source cell comprises transmitting the HO request message from the first DU to the second DU via the CU.

Clause 32: The method of Clause 31, wherein receiving the HO request acknowledgement message from the second network entity associated with the source cell comprises receiving the HO request acknowledgement message from the second DU via the CU.

Clause 33: A method for wireless communication by a second network entity associated with a target cell, comprising: receiving a HO request message from a first network entity associated with a source cell, requesting a handover of a network-controlled repeater (NCR) device to the second network entity associated with the target cell, wherein the HO request includes an indication of a first forwarding configuration for the source cell for configuring the NCR device to forward a first plurality of signals, received at the NCR device, to one or more user equipments (UEs); and transmitting a HO request acknowledgement message to the first network entity associated with the source cell approving the handover of the NCR device, wherein the HO request acknowledgement message includes an indication of a second forwarding configuration for the target cell for configuring the NCR device to forward a second plurality of signals, received at the NCR device, to the one or more UEs.

Clause 34: The method of Clause 33, wherein: the first network entity comprises a first distributed unit (DU) associated with a central unit (CU); and the second network entity comprises a second DU associated with the CU.

Clause 35: The method of Clause 34, wherein receiving the HO request message from the first network entity associated with the source cell comprises receiving the HO request message from the first DU via the CU.

Clause 36: The method of Clause 34, wherein transmitting the HO request acknowledgement message to the first network entity associated with the source cell comprises transmitting the HO request acknowledgement message from the second DU to the first DU via the CU.

Clause 37: The method of any one of Clauses 33-36, wherein the HO request includes an indication that the NCR device is a repeater device.

Clause 38: The method of any one of Clauses 33-37, further comprising determining the second forwarding configuration for the target cell based on the first forwarding configuration for the source cell.

Clause 39: The method of any one of Clauses 33-38, further comprising performing a HO procedure with the NCR device to handover the NCR device to the second network entity associated with the target cell.

Clause 40: The method of Clause 39, further comprising transmitting a first set of signals of the second plurality of signals to the NCR device for forwarding to the one or more UEs based on the second forwarding configuration.

Clause 41: The method of Clause 39, further comprising transmitting, to the NCR device, a third forwarding configuration for forwarding the second plurality of signals to the one or more UEs after completion of the HO procedure.

Clause 42: An apparatus, comprising: one or more processors, individually or collectively, configured to execute instructions stored on one or more memories and to cause the apparatus to perform a method in accordance with any one of Clauses 1-41.

Clause 43: An apparatus, comprising means for performing a method in accordance with any one of Clauses 1-41.

Clause 44: A non-transitory computer-readable medium comprising executable instructions that, when executed by one or more processors of an apparatus, cause the apparatus to perform a method in accordance with any one of Clauses 1-41.

Clause 45: A computer program product embodied on a computer-readable storage medium comprising code for performing a method in accordance with any one of Clauses 1-41.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication at a network-controlled repeater (NCR) device, comprising:
one or more processors, individually or collectively, configured to execute instructions stored on one or more memories and to cause the NCR device to:
receive, from a first network entity associated with a source cell, a first forwarding configuration for the source cell for configuring the NCR device to forward a first plurality of signals, received at the NCR device, to one or more user equipments (UEs);
receive the first plurality of signals;
forward the first plurality of signals to the one or more UEs in accordance with the first forwarding configuration for the source cell;
receive, from the first network entity, a handover (HO) command instructing the NCR device to handover from the first network entity associated with the source cell to a second network entity associated with a target cell; and
take one or more actions related to forwarding signals to the one or more UEs in response to receiving the HO command.

2. The apparatus of claim 1, wherein the one or more processors are further configured to cause the NCR device to receive a second forwarding configuration for the target cell for configuring the NCR device to forward a second plurality of signals, received at the NCR device, to the one or more UEs.

3. The apparatus of claim 2, wherein the one or more processors are further configured to cause the NCR device to perform, based on the HO command, a HO procedure with the second network entity associated with the target cell to handover the NCR device to the second network entity.

4. The apparatus of claim 3, wherein the one or more processors are further configured to cause the NCR device to:
receive, after completion of the HO procedure with the second network entity, the second plurality of signals; and
forward the second plurality of signals in accordance with the second forwarding configuration for the target cell.

5. The apparatus of claim 4, wherein the second plurality of signals comprise:
one or more synchronization signal blocks (SSBs) received from the first network entity;
one or more SSBs received from the second network entity; and
one or more unicast data signals received from the second network entity.

6. The apparatus of claim 4, wherein:
the one or more processors are configured to cause the NCR device to receive the second forwarding configuration for the target cell in the HO command; and
the one or more processors are configured to cause the NCR device to receive and the forward the second plurality of signals upon completion of the HO procedure with the second network entity.

7. The apparatus of claim 4, wherein:
in order to receive the second forwarding configuration for the target cell, the one or more processors are configured to cause the NCR device to receive a message from the second network entity, including the second forwarding configuration for the target cell, after completion of the HO procedure with the second network entity; and
the one or more processors are configured to cause the NCR device to receive and the forward the second plurality of signals after receiving the message from the second network entity including the second forwarding configuration for the target cell.

8. The apparatus of claim 4, wherein:
the first plurality of signals comprises a first set of signals received from the first network entity; and
the first set of signals received from the first network entity comprises:
one or more periodic or semi-persistent signals received from the first network entity; and
one or more unicast data signals received from the first network entity.

9. The apparatus of claim 8, wherein the one or more periodic or semi-persistent signals received from the first network entity comprise at least one or more synchronization signal blocks (SSBs) received from the first network entity.

10. The apparatus of claim 8, wherein, in order to take the one or more actions, the one or more processors are configured to cause the NCR device to stop the forwarding of the first set of signals, of the first plurality of signals, to the one or more UEs after receiving the HO command.

11. The apparatus of claim 10, wherein:
the first plurality of signals comprises a second set of signals received from the second network entity; and
the second set of signals received from the second network entity comprises one or more periodic or semi-persistent signals received from the second network entity; and
in order to take the one or more actions, the one or more processors are configured to cause the NCR device to continue to forward the second set of signals, received from the second network entity, to the one or more UEs after receiving the HO command.

12. The apparatus of claim 11, wherein the one or more periodic or semi-persistent signals received from the second network entity comprise at least one or more synchronization signal blocks (SSBs) received from the second network entity.

13. The apparatus of claim 10, wherein taking the one or more actions comprises stopping the forwarding of the one or more unicast data signals, received from the first network entity, to the one or more UEs after receiving the HO command.

14. The apparatus of claim 13, wherein, in order to take the one or more actions, the one or more processors are further configured to cause the NCR device to, after receiving the HO command, continue to forward the one or more periodic or semi-persistent signals received from the first network entity, to the one or more UEs.

15. The apparatus of claim 13, wherein:
the first plurality of signals comprises a second set of signals received from the second network entity; and
the second set of signals received from the second network entity comprises one or more periodic or semi-persistent signals received from the second network entity; and
in order to take the one or more actions, the one or more processors are further configured to cause the NCR device to continue to forward the second set of signals, received from the second network entity, to the one or more UEs after receiving the HO command.

16. The apparatus of claim 1, wherein the HO command includes a second forwarding configuration for forwarding the first plurality of signals to the one or more UEs during a HO procedure involving a handover of the NCR device to the second network entity.

17. The apparatus of claim 16, wherein the one or more processors are further configured to cause the NCR device to perform the HO procedure based on the HO command.

18. The apparatus of claim 17, wherein the one or more processors are configured to cause the NCR device to take the one or more actions during the HO procedure based on the second forwarding configuration.

19. The apparatus of claim 18, wherein:
the second forwarding configuration includes a flag that indicates to the NCR device whether or not to continue to forward the first plurality of signals during the HO procedure; and
the one or more processors are configured to cause the NCR device to take the one or more actions in accordance with the flag that indicates whether or not to continue to forward the first plurality of signals during the HO procedure.

20. The apparatus of claim 18, the one or more processors are further configured to cause the NCR device to receive and forward a second plurality of signals to the one or more UEs after completion of the HO procedure based on the second forwarding configuration.

21. The apparatus of claim 18, the one or more processors are further configured to cause the NCR device to:
receive, from the second network entity, a third forwarding configuration for forwarding a second plurality of signals to the one or more UEs after completion of the HO procedure; and
receive and forwarding the second plurality of signals to the one or more UEs after completion of the HO procedure based on the third forwarding configuration.

22. The apparatus of claim 1, wherein the NCR device comprises:
a mobile termination (MT) logical entity for the receiving of the first forwarding configuration from the first network entity associated with the source cell; and
a forwarding logical entity for the forwarding of the first plurality of signals to the one or more UEs in accordance with the first forwarding configuration for the source cell.

23. A method for wireless communication at a network-controlled repeater (NCR) device, comprising:
receiving, from a first network entity associated with a source cell, a first forwarding configuration for the source cell for configuring the NCR device to forward a first plurality of signals, received at the NCR device, to one or more user equipments (UEs);
receiving the first plurality of signals;
forwarding the first plurality of signals to the one or more UEs in accordance with the first forwarding configuration for the source cell;
receiving, from the first network entity, a handover (HO) command instructing the NCR device to handover from the first network entity associated with the source cell to a second network entity associated with a target cell; and
taking one or more actions related to forwarding signals to the one or more UEs in response to receiving the HO command.

24. The method of claim 23, further comprising receiving a second forwarding configuration for the target cell for configuring the NCR device to forward a second plurality of signals, received at the NCR device, to the one or more UEs.

25. The method of claim 24, further comprising performing, based on the HO command, a HO procedure with the second network entity associated with the target cell to handover the NCR device to the second network entity.

26. The method of claim 25, further comprising:
receiving, after completion of the HO procedure with the second network entity, the second plurality of signals; and
forwarding the second plurality of signals in accordance with the second forwarding configuration for the target cell.

27. The method of claim 26, wherein the second plurality of signals comprise:
one or more synchronization signal blocks (SSBs) received from the first network entity;
one or more SSBs received from the second network entity; and
one or more unicast data signals received from the second network entity.

28. The method of claim 26, wherein:
receiving the second forwarding configuration for the target cell comprises receiving the second forwarding configuration for the target cell in the HO command; and
the receiving and the forwarding of the second plurality of signals is performed upon completion of the HO procedure with the second network entity.

29. An apparatus for wireless communication at a network-controlled repeater (NCR) device, comprising:
means for receiving, from a first network entity associated with a source cell, a first forwarding configuration for the source cell for configuring the NCR device to forward a first plurality of signals, received at the NCR device, to one or more user equipments (UEs);
means for receiving the first plurality of signals;
means for forwarding the first plurality of signals to the one or more UEs in accordance with the first forwarding configuration for the source cell;
means for receiving, from the first network entity, a handover (HO) command instructing the NCR device to handover from the first network entity associated with the source cell to a second network entity associated with a target cell; and
means for taking one or more actions related to forwarding signals to the one or more UEs in response to receiving the HO command.

30. A non-transitory computer-readable medium for wireless communication at a network-controlled repeater (NCR) device, comprising:
instructions that, when executed by one or more processors of the NCR device, cause the NCR device to:
receive, from a first network entity associated with a source cell, a first forwarding configuration for the source cell for configuring the NCR device to forward a first plurality of signals, received at the NCR device, to one or more user equipments (UEs);
receive the first plurality of signals;
forward the first plurality of signals to the one or more UEs in accordance with the first forwarding configuration for the source cell;
receive, from the first network entity, a handover (HO) command instructing the NCR device to handover from the first network entity associated with the source cell to a second network entity associated with a target cell; and
take one or more actions related to forwarding signals to the one or more UEs in response to receiving the HO command.
